(19) United States
(12) Patent Application Publication
(10) Pub. No.: US 2005/0003146 A1
(43) Pub. Date: Jan. 6, 2005

(54) Body with improved surface properties

(76) Inventor: Bernd Spath, Ellhofen (DE)

Correspondence Address: CROCKETT & CROCKETT, 24012 CALLE DE LA PLATA, SUITE 400, LAGUNA HILLS, CA, 92653, US

(21) Appl. No.: 10/481,684

(22) PCT Filed: Jun. 21, 2002
(86) PCT No.: PCT/DE02/02269

(30) Foreign Application Priority Data
Jun. 21, 2001 (DE) 101 30 392.0
Sep. 8, 2001 (DE) 101 44 259.9

(51) Int. Cl. B32B 5/12

(52) U.S. Cl. 428/105; 428/357; 280/609

(57) ABSTRACT

The invention describes surfaces as well as combinations of surfaces which possess at least two different structure implementations. These structure formations can consist of any combinations of directed and non-directed structures, with their main formation dimensions being in the micro-meter range. By means of combinations of the surface structuring it is possible both, to improve the benefits of the individual structures and to fulfil new tasks.

The described invention relates to a body with surfaces which are equipped with structures, according to invention, and because of that they possess improved characteristics. Especially such surfaces which might get in contact with both, fluid and also solid media, and which might be soiled/contaminated by any materials and particles or which might be impurified or deposited in any other way.

Furthermore, surfaces are described which are improved by special structuring as well as combinations of materials, surface modifications, and other measures to modify shape, material and function, to the effect that surfaces will show advantages, both in the field of aerodynamic frictional resistance and hydrodynamic frictional resistance (reduction of turbulences and influence on stall and/or flow separation behavior), and also in the field of motion on the respective substrate or in the respective medium, in addition to that the surface is optimized in its function/it possibly becomes safer with respect to use and also soiling/icing-up is reduced.

In improving characteristics of surfaces, there have been attempts for quite some time now, to find possibilities, how to reduce soiling and/or how to increase the self-cleaning capacity.

Patent applications EP 0772514 and WO 00/58410 are well-known examples with respect to this topic.

They describe self-cleaning surfaces in the form of protrusions and recesses which at least partially possess hydrophobic characteristics, in different production methods and developments, like e.g. with permanently applied surface structures or with structures which can be detached by detergents.

Furthermore there are applications which relate to surfaces which describe reduced frictional resistance with flow-around media.

For example, patents DE 19650439 C1, DE 3609541 C2, where rib structures are described which affect flow boundary layers. Disadvantages of these described self-cleaning surfaces are both, the limited dimension of the applied particles of the structures and the limited production variants, and also the fact that the cleaning effect is limited to water.

Furthermore, no safety regulation aspects have been considered.

Disadvantages of applications with respect to friction-reducing structures are, that in general they describe very specific surface structures which are defined to very special applications or developments, in both, their dimension and application. Furthermore they are also limited to special application ranges (vehicles, airplanes, etc.), above all, virtually exclusively to interface-affecting characteristics and here especially to friction-reducing characteristics, e.g. to increase speeds or to reduce energy amounts required. Compared to the surface, according to invention, other surfaces especially those provided with structures, show very many disadvantages.

None of the existing structures can cover the whole range of tasks, covered by the surface according to invention. Furthermore, additional solutions are provided for application by the surface, according to invention, which can be achieved neither by presently known, friction-reducing surfaces (e.g. patents DE 19650439 C1, DE 3609541 C2), nor by the self-cleaning surfaces in the respective, described embodiments.

It will be possible with this invention, to apply certain structured surfaces under condition, not feasible so far. The invention describes an innovative surface which combines at least some of the advantages of the above described different structures, and which also possesses new, improved characteristics by suitable combination, according to invention, and developments and tasks, according to invention, of the surface structures to be described, and which provides new application options. This is achieved by combinations and formation, according to invention, as well as material characteristics of different surface structures.

A body is equipped with a plurality of surfaces which get in contact with different media,
wherein a first surface is provided with a first surface structuring in the micrometer range and/or in the nanometer range, wherein the first surface structuring is adapted to a first medium which gets in contact with the first surface,
wherein a second surface is provided with a second surface structuring in the micrometer range and/or in the nanometer range, wherein the second surface structuring is adapted to a second medium which gets in contact with the second surface.

It must be annotated that the first and the second medium can be the same media or they can be different media of the same phase (liquid, solid, gaseous), e.g. both media can be a liquid of the same viscosity or of differing viscosity, or a gas or a solid body.

It is desirable with many surfaces, e.g. due to the application of the surface of an object, as well as several or all surfaces of objects of a body, to allocated several equal or different characteristics at the same time, e.g. both friction-reducing characteristics with one or several different fluid media, maybe even with different flowing speeds and even with different approach flow directions, and also certain self-cleaning characteristics with respect to different media.

This can vary to the effect that e.g. the surface which supports self-cleaning can be developed on the same object, but in different surface areas, both hydrophobic and lipophobic, in order to be able to best fulfil the desired tasks.

In addition to that the surface, according to invention, can take over tasks apart from self-cleaning, such as the easier prevention of deposit and solidification of heavier materials on the bottom on objects (e.g. containers), they also can improve, facilitate and speed up the pouring-out of materials and/or take along material deposited on the side walls due to combination, according to invention, with suitable, direction-oriented structures.

Also, it is often useful, to equip a surface, an object or other substrates with technical characteristics, which cannot be solved sufficiently by state-of-the-art or only with very complex technical elaborateness.

The present invention describes surfaces with arrangements of structures, according to invention, which both, possess, friction-reducing and self-cleaning surface characteristics and can influence the flowing speeds and flowing directions by intentionally used developments and, moreover, retard, or if required, also accelerate the change from laminar to turbulent flows, and they can be developed in any combinations of structures according to the tasks they have to fulfil. Moreover, the surfaces, according to invention, show further advantages.

They can, depending on their application, be used for exchange of fluid media, e.g. for selective passage processes.

In addition, the surfaces, according to invention, can be equipped with functionalized surface structures or materials, in a special development.

Additionally, the combination of directed and non-directed structures provides further benefits: In special developments it is possible, to use, complete and improve the respective advantages and application ranges of the individual structuring by the other structuring each.

For example, the friction-reducing surface can be improved in its function, supported by the self-cleaning surface, to the effect that the friction-reducing surface structure can be protected from soiling and deposit by the self-cleaning surface structure, thus ensuring and maintaining the function even under the influence of contaminating fluids. Also, the self-cleaning surface structure in combination with the friction-reducing surface structure can e.g. optimized in such a way that the cleaning substances, e.g. water, etc., can be directed to where optimum cleaning is ensured or has to take place, thanks to the direction-affecting, friction-reducing surface structure.

The advantages of the surfaces, according to invention, are very versatile, they make it possible to allocate new application possibilities to surfaces and objects and also to improve and expand existing applications.

This invention can be applied to all surfaces of objects, especially such surfaces which are exposed to frictional resistance during motion, e.g. due to air friction (gas mixture) or liquid friction (water), but also due to frictional processes on, upon or with solid matters, or any combinations of these aggregation states and/or combinations of mixtures or compounds of the same aggregation states.

It is the purpose of this invention, to achieve improved frictional resistance values especially with respect to static frictional processes and sliding frictional processes and/or any combinations of theses types of friction among each other. Furthermore, this invention includes the reduction of and/or further influence on all existing sliding frictional effects, among moving bodies and moving or non-moving materials/media, as well as among non-moving bodies and moving materials/media.

The different types of self-cleaning structures constitute an important part of the surfaces, according to invention. Due to special micro-structures they can be developed in varying embodiment variations (shape, dimension, material, coating, etc.), mainly in the form of non-directed protrusions or recesses and/or protrusions and recesses, e.g. in burl shape. Among other characteristics, these structures feature very low wettability values, especially obvious by large contact angles/wetting angles with the respective, mainly fluid media (e.g. water), with the help of which self-cleaning is supposed to be supported. This applies if certain conditions are met (correct dimension of structures, distances between protrusions or recesses, and also the ratio of the correspondingly adapted heights and the distances, and also the correct material selection, suitable for the expected contaminating media and the cleaning fluids, etc.).

Which means, e.g. small droplets form almost globular surfaces on these structures which cannot adhere to the substrate and consequently drain very quickly, and which bind the impurities which do not adhere to these substrates or which adhere only very poorly by adhesion forces and consequently take along the impurities during beading, thus removing them.

Due to the individual protrusions and the gas-filled (usually air) recesses located in-between, the contaminating particles (e.g. dirt particles) show a very small bearing area (boundary layer), since the major part of the particle does not form a contact area with the solid surface.

As a result, the contaminating particle(s) develops/develop higher adhesion forces with droplets with which it/they get in contact during the cleaning process, than with the only minimally touched solid surface, and consequently it is/they are caught, absorbed and discharged by the drop of water.

On can assume that it can be achieved that the surface practically does not get dirty any more and/or can be cleaned very easily by using appropriate surface structures in the form of protrusions and recesses, made of appropriate materials (suitable for both for the contaminating materials and the respective medium which supports cleaning), in combination with contact-preventing gas inclusion between the protrusions and a mostly liquid moving medium, supporting the cleaning.

If required, the surface, according to invention, can be completed by a deliberate increase (suitable combination with the friction-reducing, flow direction-affecting, speed-increasing variant of the surface, according to invention) of speed, friction as well as the energy with which the medium support the cleaning encounters the self-cleaning surface structure. This way the cleaning effect can be intentionally used, improved or even made possible at all in some applications.

Compared to regular, smooth surfaces, certain types of micro-structured, self-cleaning surfaces achieve a contact angle/wetting angle, ideally, of up to 160° (with wax-type substances). These extremely hydrophobic surfaces are called ultraphobic. A 0 degree contact angle means total wetting, a 180 degree angle means total non-wetting.

These micro-structured surfaces are equipped with hemispherical, lenticular or burl-shaped structures which prevent the droplets from adhering and/or which cause that the dirt particles can be rinsed off very easily with water.

It is obvious that such a surface, according to invention, creates almost ideal water-repellent conditions, even more so in combination with appropriate hydrophobizing measures, such as e.g. in the form of hydrophobic phobizing materials (e.g. anionic, cationic, amphoteric, non-ionic interfacially active compounds), e.g. as spray or wax.

The micro-structures described below, mainly relate to the range of <1 mm, with the rib structures being the _m-range, the micro-structures, however, to prevent soiling, contamination, icing-up etc., can still be considerably smaller, i.e. the smallest structures, depending on the application, can range down to the nano-range.

In existing applications, the use of micro-structured surfaces is always intentionally designed for a very special application in a very special medium, e.g. frictional reduction with air or frictional reduction with water. The micro-structured surfaces used in that are normally made of a certain, mostly uniform material. And the surfaces are uniformly structured, in order to reduce frictional resistance with certain media.

The same applies to self-cleaning surface structures, they, too, are usually made of particles/protrusions of different sizes but of the same material in a product.

Combinations of different micro-structuring, like in the present invention, with different tasks, made of different materials, on different elements of a surface, show clear advantages compared to improvements invented so far.

For effective reduction of frictional resistance, different micro-structuring can be attached or applied to the respective surfaces, for the different media causing the friction.

The arrangement of the ribs, according to invention, with recesses located between two ribs each, is mainly to be applied to the respective surfaces in such a manner that these ribs are mainly arranged lengthwise with regard to the respective fluid's main flow direction to be expected, and/or the object's direction of movement or direction of motion, so that friction to be expected with the respective media can be minimized.

The lower the viscosity of the flow-around fluid to be expected, the smaller the dimensions of the structures, i.e. both the distances between the ribs, the spatial shaping of the protrusions and the heights of the individual ribs can be adapted to the respective fluids.

Since air is gaseous and water is liquid, it can be quite appropriate, to apply finer structures to surfaces of objects mainly exposed to air that than to those surfaces mainly exposed to water.

The rib-shaped surface structures, compared to all other surface structuring, also compared to very smooth surfaces, show clearly a positive effect on all flows circulating around bodies, i.e. both by turbulence-affecting effects and also possibly by retardation of separation compared to e.g. smooth surfaces.

Both effects positively influence the sliding behavior of the body circulated by fluids, especially so during flying/swimming/sliding within a uniform fluid (air/water, etc.), e.g. during ski jumping, flying, etc.

Wherein both effects show advantages on surfaces over common improvements, when the respective micro-structuring is applied to surfaces according to invention.

A general improvement with respect to frictional resistance is achieved by a lengthwise-oriented rib structure on several surfaces, in this the fineness of the structures can be made subject to the respective circulating fluid medium. By intentional structure refining and/or adaptation of the structure on certain areas of the respective body, where flow separation behavior is to be expected most likely, this separation behavior can be reduced.

The effect of these structures on the boundary layer flow—especially prone to friction—is important for the application of the structures, according to invention, since here the different characteristics of the laminar and turbulent flows take effect, especially on the change between these conditions, especially from laminar to turbulent.

The boundary layer flow is generated due to frictional forces between the flowing fluid and the body which is being circulated.

The speed directly close to the body is zero, on the outmost edge of the boundary layer the fluid's speed is the same like flowing medium's flowing speed (without frictional resistance on bodies).

On surface areas where there is a danger of boundary layer separation, it is possible, for example, to apply particularly many rib structures, with recesses adapted to the rib structures each (with respect to dimension and function), to influence the respective circulating fluid medium to such an effect that flow separation is retarded as much as possible. By additional application of structures which reduce flow separation (e.g. v-shaped fanned rib structures, if required, also appropriately dimensioned in the essential areas), and also in combination with further structures (e.g. turbulence generators), on suitable positions of an object's surface, it is possible to further increase and/or decrease the flow separation.

This entails that, for example, an flying or sliding process is not interrupted in an uncontrolled way, especially when critical, low motion or flying speeds are concerned, but, moreover, the positive conditions can be maintained longer.

In fluid media the flowing speeds are such that the border zones, i.e. the areas within fluid media which are in contact with other, e.g. solid matters, are zones where friction entails—due to the adhesion among the different materials—that here the fluids flow considerably slower than inside, e.g. of a tube, where there are only the fluid's molecules and the intermolecular frictional forces are considerably lower and, as a result, the highest flowing speed is achieved.

The Reynolds number is a dimensionless code number for the ratio of inertial forces and viscosity forces in a flowing liquid. Re=wl/v, with w being a characteristic speed, l being a characteristic length (tube diameter or diameter of a body which is being circulated), and v being the liquid's kinematic viscosity.

The critical Reynolds number is a turbulence criterion. It shows when a laminar flow changes into a turbulent one. With small low values a flow is laminar, with higher values it is turbulent.

The dimensional arrangement of the rib distances of the groove/rib structuring, according to invention, which is to be selected each on a sliding element's surface, among other factors is subject to the fact of how the fluid's kinematic viscosity (quotient of fluid's viscosity and its density) will be mainly causing frictional resistance.

The respective degree of wettability of a solid body by a certain fluid always shows a state of equilibrium between cohesion and adhesion, i.e. it shows a state of reciprocal action between the wall molecules and the other molecules of the respective liquid.

Mercury is an example of a liquid forming a large wetting angle with many surfaces. This property is based on the extremely high surface tension existing among the individual mercury atoms.

PTFE is an example of a solid matter on which liquids form very large wetting angles.

PTFE's low tendency for adhesion can be attributed to its extremely low surface energy. With 18 mN/M it possesses the lowest surface energy known of a solid body. However, due to its other properties, it has the disadvantage of possessing a very low wear resistance.

Layer systems based on carbon (a-C:h or DLC (diamond like carbon) and Me-C:H), however, possess an ideal capacity of resistance to wear.

By incorporating different elements into the carbon network, it is possible to intentionally influence the surface tension of the coatings.

It was possible to increase the wetting angle of water to over 100°, by using fluorine or silicium, thus considerably reducing wettability.

This low surface tension can thus be compared to PTFE, with the coatings possessing the hardness of ceramics materials at the same time.

Excellent adaptation to the respective requirements and media can be achieved as additional improvement and also in combination with the surfaces, according to invention.

The ideal body is represented by the streamline body.

Its air drag coefficient is 0,055.

This value is achieved because there is neither stall nor are there any big pressure differences which might cause whirls and thus turbulences. The laminar flow is maintained all over the whole body.

Due to application and development, according to invention, of the grooves, mainly lengthwise oriented with respect to the body, it can be assumed that the grooves and the upper edges of the ribs of the structuring will hamper the development of cross flows within the viscous bottom layer thus achieving turbulence reduction in the boundary layer. This, in turn, entails that there is less pulse exchange and consequently a generally lower turbulent shearing strain is to be expected. It also can be assumed that in case of slight angular approach flow against the ribs they will affect the flow close to the body in such a manner that this flow close to the body will develop more into a direction parallel to the body.

This characteristic can be used to apply the rib structures on a surface in such a way and direction as to ensure that they can be used at least partially in a flow direction-affecting way thus improving and facilitating the two or three-dimensional directing of the body (this also applies to sliding elements for ski jumping).

This effect shows the big advantage that is can be expected for both types of flows, laminar and turbulent flows, and also in this connection for gaseous and liquid media. This in turn can be utilized for different surfaces which might be structured in varying ways (since they get in contact with different fluids), and also since they might have somewhat differing tasks on the respective surface due to their position with respect to frictional reduction and thus providing advantages.

The factor s=2 h has turned out to be a good dimensional ration of the height h of the protrusions and the distance s between the protrusions h, however, the value might vary considerably, depending on the application.

Trapezoid grooves proved to be very useful, with protrusions, showing a lateral inclination of approx. 30-45°, in triangular shape, if required they also can be developed in different inclination angles. It is of course possible, to adapt the outer shape of the protrusions to requirements, as well as the angle, the distance between the protrusions and the material from which these micro-structured surfaces are made.

According to invention, it is possible, in contrary to the above, to apply certain e.g. complementing structuring in certain zones of the surface, for example structures running diagonal to the direction of motion, which can specifically drain off an excessive fluid or which can also fulfil other tasks, such as the generation of friction or turbulences. In addition to that refined or coarsened structuring on certain areas of the surface can cause other, improved characteristics of the object equipped with these surfaces.

Ideally, a main structural variant of the surface should possess rib-type structures which are applied in the direction of motion in such a way that a density of approx. 10-35, for example, trapezoidal, U-shaped, V-shaped, L-shaped grooves per mm is achieved.

This provides several benefits, on one hand a very good sliding ability is to be expected based on the reduced static frictional forces due to this kind of structuring, on the other hand the surface remains very stable in spite of relatively many ribs, due to the large number of protrusions (can be compared to the nail bed of a fakir). If required, this rib structure can be completed by a scale structure in addition.

One can proceed on the assumption that these surfaces can be still made more slidable, if the suitable lubricant, such as wax or similar agents, is applied to the surface.

The construction of surfaces featuring friction-reducing as well as self-cleaning and/or non-soiling function, can be applied to all other products, too, which are either exposed to gaseous friction, liquid friction or even a certain friction with solid matters/soiling (e.g. motion due to a not completely solid accumulation of at least partially solid individual matters, such as sand, earth, ball-type elements, granules, etc.), as well as all possible mixtures of different/the same states of aggregation, as well as mixtures of different/the same materials in the same or different states of aggregation.

The application, according to invention, applies to both, bodies which are moved due to their own power (car, bicycle, etc.), and such moved due to other powers (acceleration due to gravity, motor power, muscular power, etc.)

Micro-structuring of sports devices is especially worth mentioning since in this sector attempts have been permanently made to develop new products with even better characteristics, to gain new maximum performance and improve the general use and application.

It applies in general that there is no imperative necessity of considerably changing the outer shape, to achieve much better surface characteristics or make them possible at all.

Different techniques can be applied to produce the structures, according to invention, such as lithographic methods (e.g. LIGA-method), micro-casting, mechanical micro technology, laser micro processing, heat embossing, injection molding, plasma techniques, etc.

For the finer micro-structure restraining dirtying, sintering might possibly be suitable in addition (whirl sintering, powder and possible electrostatic powder spraying, etc.), for plastics, such as PE.

Energy is transferred into the surface of the solid matter by plasma treatment of surfaces, in a very special plasma-specific way. Plasmas are thus very suitable for surface treatments. They can activate, roughen, i.e. make the molecular elements of the surface receptive for the connection with other substances. But they are also suitable for direct surface coating by appropriate selection of process gases.

An adhesive metallization can be applied to a surface prepared that way by means of conventional palladium-infection. It is possible with this method to metallize plastics in an adhesive way which so far could not be metallized or only supported by a high amount of foreign matter additives. With the help of suitable methods, even PTFE can be adhesively metallized.

A different, large range of application for plasma-activated surfaces are surfaces of foils and plastics. When treating surfaces with low temperature plasma types, there is a further step which is usually taken than to just activate the surfaces.

The next step is functionalization.

Treatment of plastics parts with oxygen as process gas, for example, results in hydroxyl, carbonyl or ester groups, too, i.e. chemically functional molecule parts which make parts pre-treated that way receptive for further surface processes (modification of characteristics of surfaces, depending on desired requirements—hydrophobic and wax-friendly, electrically conductive, etc.).

The outward appearance of an object is determined by its surface; in the application range of modified surfaces, according to invention, especially wettability and friction play an important role here.

Plasma technology can also be used for economical production of such micro and nano-structures, according to invention. With the aid of plasma technology it is possible to apply thin ceramics structures which are micro and/or nano-structured e.g. to metal plugs which in turn can emboss, for example, materials, embossable by ceramics structures, like e.g. plastics (PMMA, etc.) with this micro/nano-structure. Structure formation of the ceramics layer takes place in a self-organising way, but the plasma process must be controlled to the effect that the self-organization desired for the respective application takes place in order to achieve the respective structure.

It is possible to produce e.g. rollers, structured according to invention, by means of plasma processes. These rollers can be made, e.g. out of metal, etc. for heat-embossing nano/micro-structures to certain surfaces of objects, and also nano/micro-structures to all other surfaces of all elements, required for the use of these objects and additionally used elements, which consist of embossable materials.

The invention described hereunder consists of a multitude of possibilities for improvement which not necessarily have to be applied to one single surface or to one and the same product, moreover, every single improvement can also be used separately. If all possibilities are used, however, the surface can be optimally adapted to the respective surrounding conditions and media.

In order to describe the advantages of the invention in their diversity of application, a winter sports sliding element is described in the first example. This example relates to sliding elements in general.

Subsequently for examples will follow in a shortened way to show the broad application range of the surface, according to invention.

### EXAMPLE 1

The first example describes snow sliding elements the surfaces of which are improved by special structuring as well as combinations of materials, surface modifications, and other measures relating to modifying shape, material and function, to the effect that the sliding element will show advantages, both in the field of aerodynamic frictional resistance and hydrodynamic frictional resistance (reduction of turbulences and influence on stall and/or flow separation behavior), and also in the field of sliding on the respective ground, in addition to that it is optimized in its function/it possibly becomes safer with respect to use and also soiling/icing-up is reduced.

This invention can be applied to all surfaces of objects which are exposed to frictional resistance during motion, e.g. due to air friction (gas mixture) or liquid friction (water), but also due to frictional processes on, upon or with solid matters, or any combinations of these aggregation states and/or combinations of mixtures or compounds of the same aggregation states.

It is the purpose of this invention, to achieve improved frictional resistance values especially with respect to static frictional processes and sliding frictional processes and/or any combinations of theses types of friction among each other. Furthermore, this invention includes the reduction of and/or further influence on all existing sliding frictional effects, among moving bodies and moving or non-moving materials/media, as well as among non-moving bodies and moving materials/media. Furthermore it is achieved by a respective application of the invention that due to the improved surfaces of the sliding elements both is obtained, an improved, safer function of the surface elements (binding, ski brake, etc.), and also a considerable reduction of the icing-up/soiling (deposit of non-desired materials on the surface) of these elements which optimizes use and wearing convenience of the sliding elements.

The sliding surfaces of skis produced today are made of polymers which can be economically produced, such as polyethylene, and usually they possess small grooves running in sliding direction (lengthwise directed), replacing the center furrow used in the past.

PE is a low-priced material which due to its thermoplastic properties can be formed both with minimal effort and also in a cost effective way.

It is the purpose of many improvements to modify the sliding surfaces of sliding elements by using new materials to the effect that the respective sliding element can slide faster on the respective ground. It is a disadvantage of many of these ideas that very expensive materials must be used or that the production of the respective soles is very expensive and elaborate, especially with respect to the fact that in doing so only a part of the sliding element can be improved.

Among other things, the disadvantage of presently used soles it their wettability. The wettability of the polyethylene material by water is still very severe due to the presently applied type of structuring.

This means that the prevailing sliding frictional forces hamper sliding of the sliding element on the ground.

Without wax the wettability values of PE-surfaces are wetting angles of below 80°, i.e. consequently a reduced sliding ability of the sliding element results from that, among other things due to increased frictional values.

In the present use, the sliding frictional forces are reduced by special wax mixtures which among other things are intended to reduce the sole's surface wettability by water.

Using good special waxes today (fluorine waxes), wettability values are achieved in form of measurable wetting angles/contact angles of approx. 120°, contrary to approx. 80°-90° wetting angles for PE-surfaces treated with regular waxes.

Furthermore, there were attempts to achieve friction-reducing effects by changing the outer shape of snow sliding elements, in order to improve the aerodynamics of the sliding element to the effect that sliding on it is supposed to be more comfortable. In addition to that, a higher sliding speed was to be enabled due to the reduction of air friction.

Many of these existing improvement show the disadvantage of being expensive and economically not efficient, moreover there are other disadvantages entailed, such as an increased weight of the sliding element or other disadvantages with respect to application, storage or use, occurring to due the differing structural shape.

A further problem which has not been sufficiently solved so far with respect to using sliding elements, and here especially snow sliding elements, is the restraint use of the snow sliding element occurring due to snow deposits on and icing-up of the upper sides of the snow sliding element.

This can mean both a safety hazard and it can also cause sliding impediments during motion and it can cause problems during buckling-on of the snow sliding element.

These problems relate to the snow sliding element itself and also to the binding area and the ski boot. It is often not possible to enter the binding and have it engage properly due to snow or icing-up in the area of the ski boot's binding and/or sole.

The solutions applied so far, however, show some disadvantages. The main problem here most likely is the fact that an object—e.g. in the form of an ice scraper—is not sufficiently attractive for a potential user.

Such an object is either disturbing, if a person is supposed to carry it always along. And it is also disturbing, and possibly even dangerous, it such an object is fastened to the snow sliding element, the ski pole or any other piece of equipment.

Furthermore, an additional product which might not always be required depending on the prevailing snow and weather conditions, is most likely to be considered as disturbing accessory by most users of snow sliding elements.

There are also differing attempts, to prevent and/or reduce icing-up and soling of safety-relevant mechanical parts at or on the snow sliding element. One of the examples are snow protectors which are attached to or on the snow sliding element which results in a higher weight, troublesome handling as well as different motion characteristics, and—of course—like the ice scrapers they also would have to be purchased as additional accessory and/or additionally attached. Consequently this means more costs and efforts for the user.

The wettability of PE-soles is reduced in the present use by applying wax onto the sole lining which itself possesses very hydrophobic characteristics. The success of waxing is increased by applying the wax at an increased temperature (approx. 130 degrees Celsius) (hot waxing). As a result of this process the wax can intrude the top layer of the polymer thus achieving an improvement of the hydrophobic characteristics of the polymer, i.e. of the sole's lining. The disadvantage of this procedure is, with respect to regularly structured soles, that the sole can only absorb and/or store a very limited amount of wax, due to its relatively coarse structure and the surface which is consequently only minimally enlarged.

The mentioned structures also show the disadvantage that the water film under the ski does not regulate to a sufficient degree under wet snow conditions and thus the excessive water cannot be discharged. This can be attributed to the presently used fine, longitudinal structuring of the sole. This can cause a suction effect if air cannot intrude in between the corresponding areas and/or was entrapped before.

Should a diagonal structure be used in addition to prevent the suction effect by leading off excessive water laterally and bringing air between the surfaces, there will be a problem of increased friction on the ground and thus reduced sliding ability which can be attributed to the structures running across the sliding direction or at an angle.

The general problem of many improvements of sliding elements is that in most cases there are attempts to optimize only a very special part of an element, a device, etc. by means of suitable improvements.

In contrary to the above, the invention described hereunder shows several positive effects, i.e. not only partially with respect to a certain part of the sliding element, moreover both with respect to optimization of individual functional units (sole, binding area, etc.), and also with respect to the functioning of the whole sliding element.

The improvement, according to invention, with respect to the sliding element is achieve by respective structure adaptation and/or new structuring or partial structuring of areas with micro-structure, according to invention, not structured so far and/or such surfaces which do possess structures, however, which can be improved and completed by micro-structure.

This clearly provides advantages and improvements compared to other solutions applied so far.

Among other purposes, the application of the surfaces on sliding elements, according to invention, is such to improve those to the effect that e.g. the sole will achieve a lower frictional value with the ground by means of suitable micro-structuring and as a result the sliding element can slide better and faster.

Furthermore the invention, applied to the remaining surfaces except for the sole, causes a reduction of the air resistance of the whole sliding element, thus additionally causing a more comfortable use as well as a faster sliding speed.

Moreover, the problem of soiling of the sliding element can be reduced and/or prevented with the help of a special variant of the micro-structure of this invention. And also the undesired deposit of snow and ice at and on the sliding element and in the binding area can be reduced and/or prevented.

Moving on the sliding element and also entering the binding are both considerably facilitated as a result.

Moreover the hazards are considerably reduced with respect to problems with the ski binding and the ski brake and/or all moving mechanical elements.

The possibility of malfunctions occurring can be reduced since the probability of occurring problems due to non-releasing/blocking of the binding and/or unintended releasing due to foreign bodies (ice, snow, dirt, etc.) can be prevented to a very high degree since most foreign bodies cannot adhere to the surface structured according to invention and/or can be rinsed off very easily by water.

Furthermore, the sliding elements, structured according to invention, as well as all other bodies structured in the same way, such as shoes, clothing, etc. get dirty less easily and show the advantage of easier cleaning and/or of getting less dirty even during open transport, e.g. on a vehicle.

Equipped with line-of-strike structures (micro-structures running mainly in direction of motion), the micro-structures rather have a friction-reducing and turbulence-reducing function, without line-of-strike structures (non-direction controlled structuring) they rather have a self-cleaning function.

There will be practically no additional costs for the user for this invention since the invention is purchased with the ski and the ski is a higher-quality product as a result of the improvements. There are no negative aspects with respect to the optimized product, such as e.g. increased weight, protruding parts which might cause injuries, or similar aspects which might reverse the advantage of the improvement into disadvantages with respect to other fields of use. Due to micro-structuring the surface area is very much enlarged. With suitable, very thin-viscosity hot waxes this kind of surface can store a very much higher amount of wax than the conventional sole lining structures. Moreover the wax intake itself is very much facilitated due to the much finer structuring.

Similar facts apply to other substances which enhance the sliding ability of a sliding element, such as e.g. sprays or liquids which prevent icing-up and which might be used instead of wax, among others, for very severely structured cross country skis.

Movement during skiing is basically influenced by two factors: the first being the air resistance, the second being the friction forces on the snow and/or the ground in general. These friction forces mainly consist of sliding frictional forces and static frictional forces.

Both types of resistance forces can be reduced by the structural modification of the sliding element's surfaces, according to invention, i.e. by suitable micro-structuring of the surface.

I.e. by micro-structuring both, the sole and also the complete upper side of the ski including the steel edges and the sidewalls of the ski.

There are many factors which can contribute to improve the moving characteristics, and also to optimize the use of a sliding element.

These improvements, according to invention, relate to the whole sliding element, including the binding and ski boots, as well as clothing and accessories of the user.

The micro-structures described below mainly relate to the range of <1 mm, with the groove structures being in the m-range, the micro-structures, however, to prevent icing-up and soiling, e.g. in the binding area, can still be considerably smaller, i.e. the smallest structures, depending on the application, can range down to the nano-range.

Combinations of different micro-structures, like in the invention described here, with different tasks, out of different materials, on different elements of a device, like e.g. a sliding element, show distinct advantages over improvements invented so far.

According to invention, the sliding element, in particular the snow sliding element, is improved in its characteristics by considerably improved values of all surfaces by respective application of micro-structuring in terms of frictional resistance, turbulence tendency and stall and/or flow separation behavior, and also by application of suitable micro-structuring, according to invention, soiling and/or icing-up can be considerably reduced and/ore prevented.

For an effective reduction of the frictional forces, different micro-structures can be attached or applied to the respective surfaces of the sliding element, suitable for the different media which are responsible for friction.

Thus a different type of micro-structuring might be suitable for the surface of the sliding element in the sole area, approx. 10-25 grooves/mm, since for every surface the micro-structuring should be selected which most effectively reduces frictional resistance with the respective fluids, since here mainly friction processes take place with relatively viscous fluids (water).

On the upper side of the sliding element the micro-structuring should be relatively fine, i.e. for example approx. 10-35 ribs/mm, since here it is mainly air (gas mixture) which acts as medium to generate frictional resistance.

The structures should be applied mostly lengthwise on the sliding element, so that they are aligned in moving direction with regular usage of the sliding element.

To optimize frictional resistance it is also useful, according to invention, to furnish both the binding and the boot, if required, on all surfaces with a micro-structure aligned in moving direction.

Furthermore, the sliding element, especially snow sliding element, is micro-structured, according to invention, in such a way (with small hydrophobic protrusions in a distributed way (burl structure), permanently attached) that soiling and/or icing-up (deposited by snow) is reduced and/or prevented and/or it can be removed very easily with the effect of water; the micro-structuring especially relates to the binding area, i.e. surface in binding area, binding, brake, as well as plate under the binding (elevation plate), but also to the parts on the boot relevant for fixing the snow sliding element to the user/person wearing it.

The respective degree of wettability of a solid body by a certain fluid always shows a state of equilibrium between cohesion and adhesion, i.e. it shows a state of reciprocal action between the wall molecules and the other molecules of the respective liquid.

PTFE is an example of a solid matter on which liquids form very large wetting angles.

However, due to its other properties, it has the disadvantage of possessing a very low wear resistance.

Layer systems based on carbon (a-C:h or DLC (diamond like carbon) and Me-C:H), however, possess an ideal capacity of resistance to wear.

By incorporating different elements into the carbon network, it is possible to intentionally influence the surface tension of the coatings.

It was possible to increase the wetting angle of water to over 100°, by using fluorine or silicium, thus considerably reducing wettability.

This low surface tension can thus be compared to PTFE, with the coatings possessing the hardness of ceramics materials at the same time.

Wax: It is the purpose, in developing different types of waxes, to achieve a contact angle/wetting angle as large as possible in the ratio of surface (PE sole) and drop of water. It seems to be a fact that contact angles of at least 80° are desirable for locomotion on snow, i.e. all improvements achieving values in excess of 120° (PE sole with fluorine waxes) are extremely interesting.

A 0 degree contact angle means total wetting, a 180 degree angle means total non-wetting.

Burled, micro-structured surfaces, according to invention, possess special structures which prevent droplets from adhering and/or which cause that dirt particles can be rinsed off very easily by water.

It can thus be established that such a surface, applied to sliding elements, would create mostly ideal water-repellent conditions, even more so in combination with appropriate hydrophobizing measures, such as e.g. in the form of hydrophobic phobizing materials (e.g. anionic, cationic, amphoteric, non-ionic interfacially active compounds), e.g. as spray or wax.

The actual sliding of the ski on snow is based at least partially on the same principle like the sliding of ice-skates on ice.

This special physical feature is based on a special characteristic of water and is called regelation. It describes the pressure dependence of the phase transition from solid to liquid states of aggregation for materials the melt of which possesses a higher density than their solid phase (water, bismuth, gallium).

Such materials can be melted under the influence of pressure, with decreasing pressure there will be solidification again. On the other hand, in addition to the regelation, formation of microscopically small droplets ensues as a result of friction. When the sliding surface of the ski slides across the snow, friction is generated and thus heat. The snow crystals are partially melted for a short time under the lining due to this frictional heat (formation of microscopically small droplets). This partial melting is responsible for the sliding process among other factors.

Excessive formation of microscopically small droplets, however, creates a water film and thus adhesion forces and a suction effect which counteracts sliding.

The sliding surface structure decisively influences the ski's sliding and also turning characteristics.

The structure reduces friction between snow and sliding surface. It is recommended to select a very fine, almost smooth structuring for dry crystalline snow, and a somewhat coarser for amorphous smooth snow, above all, to counteract a suction effect.

The presently used structure of the PE sole is treated with a special rotating stone which impresses different patterns into the ski's lining, subject to feed and rotation speed. These patterns are then used to have the ski slide on the available water film, depending on moisture conditions of the snow.

The influence of the water film on the sliding behavior of the sliding element is to be controlled by means of the fine channels, mainly running in moving direction, and to be adapted to the respective requirements.

The suction effect can be counteracted by structuring the sole, according to invention.

Due to the large number of protrusions and recesses and the continuous movement of the snow sliding element, a small amount of air, entrapped in these recesses, permanently counteracts the suction effect.

Furthermore, a hydrophobizing effect is achieved, also by micro-structuring, which counteracts the suction effect.

These hydrophobizing characteristics entail in addition that the ski shows very little friction with the ground, which possibly might result in less wear and tear of the ski sole's lining material.

Also, turbulence tendency, frictional resistance and stall of the respective flow-around fluids are reduced due to micro-structuring of the snow sliding element's surfaces, according to invention.

It is of course possible that the linings, structured according to invention, can be made of suitable materials other than the ones presently used, depending on requirement, load and task, e.g. PTFE, other plastics, surface-modified plastics, metals and metal alloys, layer systems based on carbon as well as all other suitable materials and material mixtures.

To improve characteristics decisively with respect to the use of snow sliding elements, some advantageous improvements, according to invention, will be described now with respect to the surfaces of the sliding element.

“Surfaces of the sliding element” includes all areas visible on the outsides and/or which might be exposed to frictional resistance or contaminating surroundings.

Furthermore, the invention includes surface modifications in the binding area, on the ski boot, as well as on the clothing and also on all accessories which can be worn on the body.

To improve a commodity article, you have the possibility to modify different parts of it. If we regard the ski, for example, the primary improvement that becomes obvious is sole modification. However, there is a possibility very well, too, to optimize the other surfaces as well.

The optimization of the sliding element's sole, according to invention, mainly reduces frictional resistance as well as turbulence tendencies in the hydrodynamic area.

As far as the remaining surfaces of the sliding element are concerned, micro-structuring of the surfaces, according to invention, result in the fact to achieve frictional reduction as well as a reduction of turbulence tendencies, mainly in the aerodynamic range.

The improvement means to equip the ski sole with a much finer structure, however, also mainly lengthwise, in contrary to the presently used structuring.

A comparable lengthwise structuring (applied in moving direction), offers itself for the whole surface of the sliding element which is exposed to air resistance as well as for the binding and the ski boot and all clothing of the user.

The following statements relate to a snow sliding board, and here in particular the ski, acting for all other possible applications of micro-structuring to sliding elements, according to invention.

These micro-structures, according to invention, are employed to reduce frictional resistance and also to reduce turbulence tendencies and flow separation behavior of fluid media, as well as to support the hydrophobic characteristics of the respective surface material.

Also, all surfaces, according to invention, to prevent soiling and icing-up, as well as—if required—to reduce frictional resistance are described based on the example of a snow sliding element, in particular a ski, as well as the elements, devices and equipment parts required for its use.

Based on the example of application of this kind of surface structuring to sliding elements, in particular snow sliding elements, it becomes obvious that this structuring can be dimensioned on the respective surfaces ideally in such a way that the structuring can be adapted e.g. on the surface of the sole, as well as in the edge area and—if required—also on the sides of the ski, to the friction-producing medium to be expected (snow, ice) which has at least been partly melted to become due to the melting processes described above, as a result of friction and pressure.

And also the remaining surfaces of the ski can be adapted to a different friction-producing medium to be expected, i.e. air. It is also useful to improve all surfaces of devices and bodies, attached to the sliding element, as well as all surfaces of equipment parts clothing, etc., utilized for the use of sliding element, also to the effect that they, too, should be equipped with the respective friction-reducing surface structures, if required also combined with other, e.g. self-cleaning surface structures, in the respective areas.

Of course, this concerns in particular the devices attached to the ski, such as ski binding, ski brake, elevation plates, etc., furthermore, this also concerns in particular the surfaces of the ski boot.

Compared to all other surface structures as well as compared to absolutely smooth surfaces, the groove-shaped surface structures show the advantage of having a clearly positive effect on all flows around bodies, i.e. both by turbulence-influencing effects and also possibly by retardation of separation compared to smooth surfaces, for example.

Both effects take influence on the sliding behavior of the body (e.g. in the form of a sliding element), being circulated by fluids, in a positive way, especially during sliding within a uniform fluid (air), e.g. during ski jumping.

A general improvement of the frictional resistance is achieved by means of a lengthwise oriented rib structure on all surfaces of the sliding element, and the fineness of the structures can be made subject to the respective flow-around fluid medium.

By purposive structure refining and/or adaptation of the structure to certain areas of the sliding element, where flow separation behavior is most likely to be expected, this behavior of the sliding element can be reduced, like e.g. in the rear binding area and also at the tip of the sliding element, etc.

It is useful on those areas, to apply particularly many rib structures with the respective recesses, adapted to the rib structures (with respect to dimension and function), in order to influence the respective flow-around medium to the effect that flow separation is retarded as much as possible.

Due to application and development, according to invention, of the grooves, mainly lengthwise oriented with respect to the body, it can be assumed that the grooves and the upper edges of the ribs of the structuring will hamper the development of cross flows within the viscous underlayer thus achieving turbulence reduction in the boundary layer. This, in turn, entails that there is less pulse exchange and consequently a generally lower turbulent shearing strain is to be expected. It also can be assumed that in case of slight angular approach flow against the ribs they will influence the flow close to the body in such a manner that this flow close to the body will develop more into a direction parallel to the body. This characteristic can be used to apply the rib structures on the sliding element in such a way and direction as to ensure that they can be used at least partially to affect the flow direction thus improving and facilitating the directing of the sliding element (during sliding and during turning, as a result of respective structuring applied to the edge area of the steel edges) (this also applies to sliding elements for ski jumping).

Ideally, the primary structure of the sole should possess groove-type structures applied in moving direction, thus achieving a density of approx. 10-25 e.g. trapezoid, U-shaped, V-shaped, L-shaped grooves per mm (FIG. 1).

This provides several benefits, on one hand a very good sliding ability is to be expected based on the reduced static frictional forces due to this kind of structuring, on the other hand the surface remains very stable in spite of relatively many ribs, due to the large number of protrusions (can be compared to the nail bed of a fakir). If required, this rib structure can be completed by a scale structure in addition, this is particularly useful for cross-country applications or touring.

One can proceed on the assumption that these surfaces can be made even more slidable, if the suitable lubricant is applied to the surface, such as e.g. wax or a similar product. Presently, the majority of alpine skis are equipped with a lengthwise structured sliding surface. However, the presently used structuring consists of a much more coarse grid (FIG. 8a).

Presently, there are approx. 2-3 protrusions and/or indentations per mm.

Furthermore, the raised areas are much wider than the indentations on the presently used linings. In addition, the presently used sliding surfaces are absolutely uniform, equipped with always the same types of structuring.

In contrary to that, certain e.g. complementary structuring can be applied to certain zones of the ski, according to invention, e.g. structures aligned diagonally to the moving direction, which are able to drain water towards the outside. Additionally, refined or coarsened structuring on certain areas of the sliding element, can ensure improved moving characteristics.

It is possible to use both, standardized always identical structures with identical distances between the ribs, and, alternatively, optimized structures which can be adapted to the respective requirement in an optimum way (speed giant slalom, maneuverability slalom, as well as different snow or weather conditions).

Finer or coarser rib arrangements, e.g. in certain zones of the sliding element's sole cause modified frictional forces. Moreover, by means of number and structure of the protrusions, the bearing area of the sliding element on the ground (snow) can be modified.

This provides the possibility to increase the pressure per cm² due to a smaller bearing area and thus influence can be taken on regelation/formation of microscopically small droplets and an increased or decreased water film can be generated which, in its turn, modifies sliding friction on the ground.

Edges are produced as one-piece edges or segmented edges in different hardnesses of steel. Hard steels are more resistant, however, more difficult to process.

Heat-treated steels, used as edge material, are a relatively new development, they maintain their sharpness longer than regular material, however, their manual tuning is more difficult.

The edge grip can be improved by furnishing the edges with a micro-structure, according to invention, which can e.g. run in moving direction, oblique or perpendicular to the moving direction, and this way the desired effect can be achieved (reduction of frictional resistance during moving or better grip when setting the sliding element on edge for braking).

In addition to the improvements, according to invention, in the form of suitable micro-structuring, both the shape and the material of a sliding elements structure can be used, according to the developments of the present invention, to provide the sliding element's surface, according to invention, with higher elasticity.

Furthermore, it is possible to apply the developments of the micro-structures, according to invention, to other materials which replace the former materials of sliding elements' surfaces as a whole or in part, in order to achieve the desired elasticity.

If not only the sliding element itself accumulates tension due to its design and this tension can be converted into sliding dynamics, but the sliding element's lining, too, can convert tension into dynamics, this means a further improvement in addition to the improvement due to the micro-structured surface possessing the advantages mentioned above.

Elasticity can be achieved by selecting the material to the effect that the protrusions (ribs) are developed in a rigid and relatively edged way, to prevent cross flows as much as possible. The material of the protrusions, however, may very well be movable (e.g. scale-shaped made of rigid materials), the material selected for below the protrusions, however, can alternatively be elastic.

### EXAMPLE 2

The second embodiment example shows, e.g. surfaces of objects such as buildings, constructions and comparable bodies, which can be both, exposed to mainly fluid frictional forces from different flow directions and of different materials, and possess surfaces which are to fulfil self-cleaning functions. An advantageous formation of the inventive object provides, for example, to furnish surfaces of objects which can be exposed to fluid or generally moving media, with surfaces, according to invention.

These surfaces and also the objects surrounded by them, provide enormous advantages, e.g. with respect to buildings or other bodies, over other surfaces.

A bridge over a river may serve as a specific example in this case.

An embodiment of the surface, according to invention, can be represented by a body consisting of different materials, exposed to different fluid media, in addition.

Furthermore, the intention is both, to prevent soiling as much as possible and to keep the whole material consumption as low as possible and to optimize the stability of the building.

All these requirements can be supported with the surface, according to invention.

Thus, surfaces located under water (supporting elements, etc.) can be structured with a formation of the surface, according to invention, to the effect that friction-reducing surfaces are applied which are adapted to the fluid medium water, applied mainly in flow direction which can reduce flow friction of the impacting and flow-around water masses and possibly they can also be used in a way affecting channelling (if required, of course also combined with other structures and surfaces).

This way, both a stabilizing effect can be achieved with respect to the complete system “bridge” due to the reduction of the water pressure, thus promoting stability and safety, and also the total material consumption can be reduced since the same static stability can be achieved using less material due to the decreased water pressure.

By application of the surface, according to invention, it is also possible to apply a friction-reducing surface to all desired surfaces of construction parts of the bridge area located above the water; combined with surface structures with self-cleaning characteristics which ensure in relevant sections that soiling, icing-up, etc., can be cleaned very effectively and in particular by wind and water.

The same applied, of course, for all areas located under water.

Thanks to the application of the surfaces, according to invention, it is also possible to achieve an improvement of the characteristics under water, like, e.g. reduction of moss-coverage and fouling due to algae, and of soiling in general.

All types of scaffolds, masts and supporting elements represent also an example for a group of objects which can be constructed the surfaces, according to invention.

For example, scaffolds structured with the surfaces, according to invention, get much less dirty which should be of great interest in the building trade. On the other hand, the scaffolds' function is improved to the effect that less frictional forces occur (e.g. due to wind load stressing, rain showers, thunderstorms) resulting in better stability.

And in addition, occurring deposit, in particular dirt, snow, ice, etc., is considerably reduced on these surfaces by means of the surfaces' self-cleaning characteristics, compared to presently used surfaces in this sector.

These self-cleaning characteristics provide diverse benefits which may not only result in saving of cleaning efforts and aesthetic developments, but which can also show safety-relevant aspect.

Thus, respective surfaces can dry faster, ice-up less and accumulate less dirt in general, if equipped with the respective formations of the surface, according to invention, which otherwise might possibly cause accidents, hazards and malfunctions.

### EXAMPLE 3

Different surface structuring can also prove to be advantageous for moved or moving objects, e.g. vehicles (water, land, air).

Frictional reduction with the fluid medium water is for example desirable for water vehicles, but frictional reduction with the surrounding air is also of interest. The structuring can differ subject to the respective fluid.

It can also be of interest to apply different alignments of the structures to a surface (ship's hull) since not only the moving direction itself should be considered, but also the flow direction occurring on individual areas of the body as a result of the shape of the moving body; and consequently different types of structuring can be combined accordingly and thus prove to be beneficial.

The self-cleaning characteristics of the surfaces, according to invention, are relevant in all areas, anyway.

However, many surfaces should also be equipped with self-cleaning structures to be able to remove adhering particles quickly and, if possible, without residue; in particular for safety-relevant, more user-friendly, work-facilitating, etc. functions.

Obviously, friction-reducing characteristics are useful and important, above all for quickly moved or moving or flown-around areas and objects, e.g. for energy saving, but also to increase performance, as well as—if required—for optical and decorative purposes.

The surface, according to invention, can also be applied to all super-structures and complementing bodies, e.g. on sails, masts, wheels, etc.

This, above all, also applies to purposes and applications where maximum performance is called for, like e.g. with respect to the optimized application of devices and objects used in competition.

But these structures, according to invention, are also beneficial for all other surfaces.

An example can be given based on a bicycle.

According to this example, the surfaces of every element of the bicycle are improved by means of variations of the surface structures, according to invention.

Consequently, every surface of every part of the bicycle, exposed to frictional resistance by air, can be equipped with the respective structures, if required also in different combinations, as well as in combinations self-cleaning surfaces to prevent soiling and deposit which might impair e.g. the functioning in general and also functioning of the friction-reducing structures.

But there are structures, of course, too which can be very relevant for the self-cleaning surfaces, like for example parts of the device which might get in contact with the user, or also parts which might be impaired in their function as a result of soiling.

A main element of this kind can be the saddle, for example.

Here it can be achieved that the saddle will neither get dirty thanks to the appropriate application of the structures' self-cleaning development of the surface, according to invention, nor unnecessary turbulences are being generated as a result of suitable combination with friction-reducing surface developments, e.g. on the areas not occupied by the person riding the bicycle (bottom side, rims, etc.).

Furthermore, combinations of two or more structures can ensure that the remaining saddle areas which are mainly self-cleaning, can be equipped with additional abilities.

It is possible to achieve a friction-reducing effect of the top side as well, by suitable combination of surfaces which is especially important for riding in upright standing position. But these surfaces provide may more advantages, such as, among other advantages, better evaporation of sweat. The sweat can evaporate very easily due to the respective structures and/or drain off as well in a directed way.

Comparable applications apply to the area of the handlebar, etc., as well to all surfaces of object and other substrates on or at the described objects.

Comparable facts apply to all other surfaces of objects, e.g. sports devices, implements and leisure devices and objects which can be moved, which move themselves or which can be surrounded by moving materials, such as inliners, ice-skates, sledges, skeleton, bobsled, kickboards, surfboards, boats, kayaks, canoes, sailing and motor ships, kite-boards, parachutes, hang-gliders, sky-diver equipment, etc.

### EXAMPLE 4

A further application sector of the surfaces, according to invention, are surfaces in fields, too, where hygienic improvements are to be aimed at besides new and improved application possibilities, like e.g. in the medical sector.

This is especially important for all surfaces which might be soiled or—in particular—contaminated, since suitable surface structures, according to invention, even prevent adhering of germs and other pathogenic agents or make it at least more difficult; and, above all, they facilitate and speed up cleaning. Moreover, other problems can be solved by the surfaces, according to invention, e.g. the problem of friction with matters should not be underestimated. Friction-reducing characteristics are advantageous with respect to all surfaces which might get in contact in particular with fluid materials, especially when these characteristics can be combined with direction-affecting characteristics with regard to the respective flow-around media.

A corresponding application example is given, as follows, based on a catheter.

Usually, a catheter is a tubular element which is e.g. inserted in a body. In the medical sector it is often used s well, to transport any, mainly fluid media.

The following surface combinations, according to invention, can be applied to this special case with respect to the surfaces of an object, to achieve the advantages described below.

It is absolutely possible that a relatively viscous product is to be transported inside of a cannula, whereas the outside of the cannula mainly gets in contact with endogenous materials and liquids.

Both, the inside of the object and also the outside can be furnished with the surface, according to invention.

Furthermore, it is the purpose to prevent or at least minimize soiling and also contamination by foreign substances and especially by pathogenic germs. Therefore it is important here, to complement or to combine the friction-reducing surfaces with self-cleaning surfaces.

This results in many advantages. The objects can transport materials more easily, they can be emptied better and get less dirty.

Furthermore, these objects can be inserted easier into a body and removed again since adhering of materials on the outside, too, can be prevented and/or reduced.

The hygienic characteristics can also be improved.

Also, longer dwelling within a body will cause less problems, e.g. in the special case of a catheter in the field of bypasses, which must continuously transport fluid media (blood), under the condition that there should be no problems in terms of fluctuating flowing speeds, new deposit on inner walls, pathogenic germs, rejection reactions, etc.

All these characteristics and abilities can be applied to all surfaces of medical objects in suitable combinations.

Of course, these can also be complemented by any other surfaces and characteristics which can be advantageous for the respective applications.

A further application example is represented by a surgical instrument, e.g. for minimal-invasive use, like e.g. used for liposuction. Here, too, the use of the surface, according to invention, will result in improved characteristics. A friction-reducing surface shows advantages, both in the inside area and also outside.

The materials to be sucked away can be sucked faster, easier and more effectively. The outside surface of the device, however, can be moved inside the body back and forth along the tissue with less effort required, and, above all, in a much gentler way with respect to the patient.

In this field it is the hygienic aspect of self-cleaning surfaces which of course is of great importance.

In addition to the mentioned medical surfaces, the surfaces, according to invention, can also relate to other surfaces of objects also used for medical purposes, which are not very obvious to be included in this category.

In this special application example, all surfaces of objects are concerned which can be absorbed by a body (living being). A prominent application example in this case is represented by all objects which can be taken orally, in particular medication in the form of capsules, tablets, pills, etc.

Here, too, the surface, according to invention, opens up new possibilities.

For example, all formations of capsules, tables, pills, suppositories, etc., can be developed in the surface combinations, according to invention. Depending on application, different combinations may be required to achieve optimum results.

All these applications and the advantages resulting thereof can, of course, be applied to and used for all surfaces. Application of the surfaces, according to invention, in any implementations can also be transferred to all other objects which are moved in a medium, moved in a moving medium or, also, which are flown-around by a medium.

In addition, all surfaces, according to invention, too, which are moved on a moving or non-moving medium.

In addition, the surfaces, according to invention, can, of course, also take over additional tasks. Thy can, e.g., be aimed at achieving certain other effects, and, of course, they can consist of any materials and can be combined with all other surfaces.

It is also possible, for example, to produce protrusions of individual structures or of all structures out of medically effective or otherwise effective materials (depending on application or task), which can take over certain tasks in addition to the medicine or complementary to the medicine in the inside of the capsule.

Thus it is for example possible that the surfaces, according to invention, can consist of structures dissolving as a whole or to some extent. These structures can take over certain tasks, such as e.g. to facilitate sliding by generation of gel, mucin, or foam; but they can also take over medical/pharmaceutical tasks by means of released active substances.

### EXAMPLE 5

All kinds of containers and tubes which can get in contact with movable media as well as other media to some extent, can also be structured with the surface, according to invention, in suitable combinations.

A useful physical form of the inventive object can show the following characteristics with respect to containers.

Many exemplary containers are intended to hold materials and—in most cases—to release them again.

If any container is equipped with a type of formation of the surface, according to invention, it can be achieved that the container can be easier and faster filled and emptied, cleaned, kept clean in general and, furthermore, e.g. emptying and filling can be carried out in a more controlled manner.

Taking the example of a garbage can, it is possible to develop e.g. the bottom area mainly in self-cleaning manner, the inner wall elements, however, can alternatively be equipped with friction-reducing surfaces. And the upper edge area (filling and discharge area) can be equipped again with self-cleaning surface characteristics, and the outsides can be equipped, e.g., with a combination of friction-reducing and possibly self-cleaning surfaces, too.

This embodiment provides many advantages.

The self-cleaning bottom area can prevent dirt or lager objects from adhering. The container can be emptied completely and can be easily cleaned, in particular by water.

Furthermore, above all, contaminating materials such as fungi, pathogenic agents and other dangerous materials are prevented from adhering to the object's bottom for a longer time and multiplying there.

The wall area, mainly equipped with the friction-reducing surface is intended to make emptying of the containing material possible, fast and completely, supported by the self-cleaning bottom surface.

The upper opening area, however, should not get too dirty and consequently it can be equipped with self-cleaning surface characteristics.

This way nothing will stick to it and/or sticking materials can be removed very easily.

The object's outer area, however, also should not get dirty, since garbage cans are outside very often and for a very long time, and they are exposed to many different materials, such as dirt, snow, ice, etc. Furthermore, it is advantageous if equipped with a friction-reducing surface in a complementary way, which, among other factors, shows the benefit that the container is less prone to be knocked over by wind or squalls. Further application examples are all kinds of containers which are to be emptied in such a way as well, as to leave as little residue within the container as possible, like e.g. food containers which will be recycled.

One example is represented by yoghurt cups which always should be rinsed by water to prevent mildew, etc. as well as olfactory nuisance. The application, according to invention, is advantageous in this case, too.

In a further type of formation of an object which e.g. can be filled and emptied, further advantages can be achieved in application by adapting e.g. the surfaces, according to invention, to the respective use and by complementing them by further characteristics.

By application of the surfaces, according to invention, it is e.g. possible to optimize them to the effect that e.g. the emptying speed of an object can be increased or turbulences can be reduced within the material to be discharged. Artificial mechanisms can be employed to increase emptying speeds beyond the friction-reducing abilities of the surfaces, according to invention, such as pumps, etc., but, of course, natural forces can be employed as well, such as gravity, pressures, etc. or also the Coriolis force.

The Coriolis force can be used to the effect that especially during emptying processes, carried out ideally perpendicular to the earth's surface, the Coriolis effect can be used by means of the surfaces, according to invention, to either accelerate emptying or, if required, it can also be employed to produce e.g. increased frictional forces between the material to be discharged and the walls of the container. This can be implemented, e.g. as follows. The friction reducing surface structures—since they can also act in a direction-affecting way—can be applied to the inside of the container in such a manner, for example, as to set the discharging material in a rotating movement. This rotating movement can have an accelerating effect on the Coriolis force occurring there, so that the two processes can complement each other. This results in a faster rotation movement of the medium to be discharged which can be utilized for much faster emptying of the whole medium.

The friction-reducing surface, e.g., in the form of groove and rib structures, can be employed here to the effect that, for example, the moving direction of the substance to be discharged can be affected by means of a screw-shaped, helical arrangement of the structures. Either in a way to cause acceleration or in a way to decelerate the flowing and rotation speed. This way friction can be increased, so that particles possibly adhering to the container wall in addition can be repeatedly removed and/or thus produced turbulences can be utilized (e.g. gas admixed).

Moreover, the discharging area of the object can be equipped with self-cleaning surfaces to always keep it free from soiling.

### EXAMPLE 6

Tubes in general represent a further important application range, and, especially, in this application example, the narrowings of tubes are concerned.

An exemplary embodiment of narrowings of tubes is represented by all kinds of nozzles, valves, etc. Here it is the purpose, too, to achieve improved surfaces of narrowings, inlet and outlet openings, e.g. on nozzles and adjacent surfaces. This example of the surface's application, according to invention, relates to an improvement with regard to the spraying characteristics, and also the tendency of nozzles to get dirty and sticky, and the surfaces related to that.

In principle, a nozzle is a flow channel which possesses a changing diameter. Since this concerns a flow channel, a friction-reducing surface is always a suitable means to achieve optimized flow values.

Furthermore, adhering of disturbing particles or liquids should be prevented as far as possible both to the discharge area and also to the narrowest area of the nozzle. This is achieved by application of surface structures, according to invention. The whole product (nozzle) can be optimized with respect to its characteristics only by a deliberately selected combination of the surface structures, according to invention. All shapes of nozzles as well as all adjacent areas can be structured according to the micro-structuring, according to invention, in order to be equipped with surface structures as ideal as possible.

A special application example can be represented by an aerosol atomizer, for administration of fluid media (e.g. suspensions).

This object can be equipped with surfaces, according to invention, e.g. as follows:

The inlet area of the nozzle as well as the outlet area of the pressure container can be equipped with friction-reducing surfaces, but also the whole interior space for atomizing the aerosol, in order to achieve flows as frictionless as possible.

In addition to that, the direct outlet area of the nozzle and also the edge zone of the interior space where materials might deposit, can be equipped with the surface, according to invention, to the effect that no adhesive soiling or deposit will occur and/or these can be easily removed. It is also very important to equip the outside which gets into the mouth during use, with self-cleaning surface structures, according to invention, so that germs, pathogenic agents and other deposited materials can be easily removed thus achieving improved hygienic characteristics.

### EXAMPLE 7

A further interesting application of the surface, according to invention, can be to the effect that e.g. in the field of objects with are prone to soiling, e.g. in the form of instruments and devices, the surface, according to invention, can be applied to the following instrument in following embodiment:

This example relates to razors, in particular wet razors, where usually severe soiling occurs during use and also a smoothly sliding surface is desired. Now the surfaces can be developed e.g. as follows: at least part of the surface of the razor head serves to ensure the blade or blades will slide across the skin, mostly at a defined distance, as frictionless as possible.

A surface producing relatively low friction resistance with the substrate is appropriate for these areas, to ensure sliding will be as frictionless as possible

Furthermore, above all, the spaces in-between multiple blades which get extremely dirty and all other surfaces of the razor which are prone to get soiled are suitable to be developed as self-cleaning surface embodiments. By appropriate combination and embodiment of the surface, according to invention, it can furthermore be ensured that the blades themselves, if required on top and bottom, are equipped with respective structures, causing the soiling materials both, to slide off more easily to intended directions and also to be removed (these contaminating materials) easier by flowing water.

These application examples of the surfaces, according to invention, can of course be varied in any form and provide the advantage that smoother, easier shaving is made possible, since the friction-reducing surfaces achieve ideal friction-reducing effects in combination with the media usually used for shaving, such as water, soap, foam, etc.

Likewise, the application of the self-cleaning surfaces, according to invention, acts in combination with the mentioned media and the additionally occurring soiling objects (hair, cutaneous scales, etc.), to the effect that all soiling can be cleaned off very easily by water (involved in the process anyway).

By using respective surface structures, according to invention, in particular in the blade area, hygienic characteristics, too, can be improved to the effect that inflammation tendencies, caused by germs clinging to blades, can be minimized.

Furthermore, the structures can possess characteristics, for example, reacting in an antiseptic, haemostatic, etc. way. But in addition to that they can be developed in a way that intended material abrasion is achieved,

e.g. to indicate conditions (object no longer fully functional) or to produce complementary functions (dissolving protrusions produce e.g. lubricating film, foam, etc. or also antiseptic ingredients), and for release and functionalization of functional surfaces or structures, possibly available below the protrusions.

Further application examples are instruments and devices, such as dry razors, tooth brushes, massage instruments, etc.

### EXAMPLE 8

In the jewelry sector, too, the surface, according to invention, provides many advantages.

The surface, for example, can be combined in such a way that e.g. on a wrist watch all areas which might get in contact with the skin of the person wearing the watch can be equipped with friction-reducing surfaces. All other areas, especially those turned outside and visible, can be equipped with self-cleaning surfaces.

The rib/groove structures e.g. on the bottom of the wrist watch can ensure that the contact area with the skin is relatively small, which, among other results, might entail that the person wearing the watch will sweat less, that sweat, possibly occurring nevertheless, can evaporate faster. And for this reason the materials of the watch might be less attacked on one hand (acids, fats, etc. of the skin), and also the materials can maintain their original outward appearance for a longer time.

Furthermore, it might be possible that the occurrence of allergic reactions is less probable.

The self-cleaning surface can also contribute to ensure that the piece of jewelry can maintain its original outward appearance for a longer time, it is easier to keep in good condition and will get less dirty.

Of course, this example of a combination of the surface, according to invention, can be varied in any possible way. A second application range is represented by body jewelry which is fixed through the body's surface.

This includes all kinds of piercings.

Application of the surfaces, according to invention, is very well suitable in this range, especially due to hygienic advantages and the advantages mentioned in the above example.

### EXAMPLE 9

The surfaces, according to invention, prove to be advantageous for all surfaces of objects, too, which can get dirty, in particular, if these objects are exposed to different conditions, e.g. outdoors.

The surface, according to invention, provides a decisive advantage, e.g. for furniture pieces etc. which might be outdoors at times.

There is no need to explain the advantages of the self-cleaning surfaces in this application example in more detail. But the friction-reducing, flow direction-affecting surfaces are also very important in this connection.

Both the object's stability can be enhanced by means of appropriate combination of the different surfaces and also a supporting effect for the self-cleaning surface.

The self-cleaning effect can be supported for all bodies due to the direction-affecting effect caused by the friction-reducing surface, since when using this structure the fluid which supports the self-cleaning process can be directed in certain directions and thus achieving a very good cleaning effect.

Especially those objects which put up a high resistance to possible flows are better protected against damage, too, by means of the friction-reducing surfaces since normally will tilt over or tear up less often (parasols, laundry racks, decoration elements, plant tubs, etc.).

### EXAMPLE 10

The structures, according to invention, can be applied to all types of surfaces.

Some application examples are surfaces belonging to a person's living, working and leisure environment (e.g. furniture, kitchens, bathrooms, etc.).

In all these sectors and all other sectors, self-cleaning characteristics are always very advantageous.

However, by suitable combination with other aspects of the surface, according to invention, further advantages are achieved.

It is possible here, too, like with all other surfaces, according to invention, to develop both friction-reducing and direction-affecting surfaces in combination with suitable directed structures, which lead e.g. liquids well-aimed to the self-cleaning surface.

Beyond that it is also possible that application of the non-directed structure which is very sensitive to mechanical influence is enabled only by the presence of a second, larger structure which is mechanically more stable which protects the finer surface in suitable application e.g. by embedding the finer structure as a whole or to some extent into the larger structure or that the larger structure projects above the finer structure in other types of application, as well.

Ref. to FIGS. 5a and 5b, where the non-directed structure is embedded in the directed structure, as well as FIGS. 3c, 3f, 3h and 3j, where directed structures are protected against mechanical influence by structures which are also directed (of larger dimension). In FIG. 2h to 2m non-directed structures are protected by other non-directed structures (of lager dimension). Regardless, all variations of the surface, according to invention, can also be used for decoration and design purposes.

### EXAMPLE 11

The surfaces, according to invention, are also suitable to be used on shoes, since e.g. for soccer shoes, a surface combination in the manner, according to invention, keeps soiling and thus the weight during wearing as minimal as possible. And, furthermore, the friction-reducing surface provides the advantage that the foot can be moved producing much less air friction which results in higher shooting□ speeds, e.g. when shooting a ball.

### EXAMPLE 12

In all forming processes/embossing processes, etc. (e.g. tool making/thermoforming/ejection molding) the surface, according to invention, can be developed in all variations on the master molds (forming tools) resulting in products, formed according to invention, which can possess all advantages of the surfaces, according to invention.

Furthermore, the surface, according to invention, can also facilitate demolding and ejection of the finished products after the forming process, since the adhesion forces are reduced.

### EXAMPLE 13

The surfaces, according to invention, are also advantageous for transport devices which are used for the transport of media or for transport devices in which media are being transported.

Among other factors, a faster flow speed is achieved by means of friction-reducing structures or less pressure is required to move a fluid medium through an object.

Furthermore, foaming fluids (e.g. beer) can be filled in faster by affecting the type of flow (laminar/turbulent), which can cause less foaming of the fluid. Besides that, there is a possibility of better cleaning and less tendency of germ development by combination with self-cleaning surfaces, in particular on the inlet and outlet area.

### EXAMPLE 14

Films in the sense of independently usable surfaces or surfaces to be applied are also well suited for application of the surfaces, according to invention, in all variations and combinations.

Since both, reduction of soiling and the friction-reducing effect of the surface, according to invention, are actually advantageous for all applications.

It does not matter if packages are concerned or surfaces in general, since in every case the surface, according to invention, provides advantages and sometimes even enables completely new applications.

A further application example in this field is represented by protection films which are used to protect against soiling and damages, etc. For example materials which have to be pulled off only after an object has gone through e.g. transport, installation, etc.

By application of the direction-affecting surface with respect to the surface, according to invention, it can be ensured, in addition to all other advantages, that contaminating or soiling objects can be led off to a certain direction, away from the object to be protected.

This can be implemented in a way, e.g. that a surface, possessing self-cleaning and friction-reducing characteristics, is equipped with structures to the effect that contaminating material can be led off, both during attempt of cleaning, e.g. by water, and also with the help of natural processes (gravity, wind, rain, etc.).

Further important application possibilities are covers, films and fabrics.

### Example 14a

A further application possibility is represented by cloth-type or film-type surfaces, which get in contact with moving media, like e.g. sails of surfing elements.

It is their task to move an object with the help of flowing media. For this reason, complementary structures, equipped with the mentioned characteristics, are certainly a useful completion, since the characteristics can be optimized by those. By using the surface formations, according to invention, the air flow can be led along surface more smoothly, but it can also be decelerated by suitable arrangement or embodiment, which can be employed to increase the propulsion.

Surprisingly, a surface structure, according to invention, provides at least one further very important advantage. Among other advantages, this rough surface formation, according to invention, especially if equipped with protrusions, provides the advantage of greatly reducing the adhesive characteristics of smooth surfaces.

The tendency of adhesion can be reduced by implementing appropriate dimensioning and spatial arrangement of the structures, as well as by completing them with other surface characteristics, if required. And also the possibility of self-cleaning can be enhanced supported by beading-off liquids.

Among other facts, these characteristics make it possible to facilitate the problematic lifting off of the sail form the water surface very much (upon every climbing back onto the surfing element), since air inclusions between the surface structures reduce the clinging of the sail onto the water surface. And this way resetting of the sail is very much facilitated. Thus the application of the whole sports device can be improved.

### Example 14b

A further possible application are all kinds of surfaces where fluid media are led along, e.g. shower curtains.

Here, too, the application of the surface structures, according to invention, can lead to advantages, both with respect to soiling (mildew, lime, etc.), and also application in general.

Due to the application, according to invention, it can be achieved for very fine, raised surface formations (if required, hydrophobized), that water which meets with the surface will bead off very quickly, thus removing most contaminating particles.

This can also be achieved in combination with other micro-structures (hydrophobic), which are protected from mechanical damage by a surface development, structured according to invention, possessing coarser structures than the one only aimed at self-cleaning. Moreover, implementation and arrangement of the directed structures, according to invention, can be developed in such a way that the water applied is directed purposely and well-aimed to the effect that all surfaces can be optimally supplied by water.

Beyond that, in contrary to firmly installed shower walls, there always is the problem of the adhesive characteristics of smooth and other surfaces e.g. extremely hydrophilic and also self-cleaning surfaces. They cause problems during the use of the shower equipment.

The problem is that the shower curtain which is usually movable will approach the person taking the shower and cling to his/her body as soon as water starts flowing out of the shower and as soon as the body of the person taking the shower and the curtain are wetted.

This process is extremely annoying. It hampers the person while taking the shower, contaminates the shower curtain with cleaning agents and the person possibly with impurities which adhere to the shower curtain (mildew, germs, dirt, etc.).

It can be assumed that this process is caused by the hot, flowing water, the difference in temperatures between the interior shower space and the rest of the room, as well as by the hot up current occurring during this process. Furthermore, static charging might also be involved in the process. According to invention, the tendency of approaching and clinging is considerably reduced by the fast beading-off of the water as well as by the air entrapped between the protrusions to minimize adhesion, and also by the small surface of the shower curtain which actually touches the skin, and also by the non-existing adhesive effect of a water film, as well as by the non-existing hydrophilic surface.

And also, the approaching and/or clinging can be furthermore reduced since especially in the bottom area protrusions prevent the direct contact between two surfaces curtain/curtain or curtain/shower tray, and thus soiling and the production of germs can be prevented, moist zones are avoided.

### Example 14c

A further development of this invention can be used for roofs of convertibles.

Here, too, the applications, according to invention, represent ideal improvements to optimize the characteristics of the surface.

In this case the structures can be employed to reduce the frictional resistance with fluid media. By special arrangement, shape and dimensioning of the elements it is furthermore possible to enhance the stability of the surface and to improve aerodynamics.

The tendency of the construction element to get dirty can be considerably reduced by suitable arrangement, dimensioning and material selection.

This special application variation is in particular suitable for convertible roofs since here a polishable surface is not as absolutely compelling as for the lacquered sections of the vehicle.

In special application variations, the surface structure, according to invention, can be developed and applied in such a way that it can also purposely affect flows and produce resistance, e.g. to direct air flows to the effect that the suction pull resulting from the accelerated air stream to the roof top during high speeds is reduced and consequently swelling of the roof can be reduced. In this connection other surface developments can be complementary used to optimize this effect.

### EXAMPLE 15

Accelerated bodies (javellins, boomerangs, arrows, projectiles, balls, etc.) or other objects to be found within fluid media or moving objects, are also nothing else but objects with surfaces. However, since in this connection very fast motion, in particular through fluid media, plays an important role for the application, and also avoiding or minimizing the soiling of the object is advantageous, this product group is very suited to be equipped with the surfaces, according to invention.

The application of the friction-reducing structure, according to invention, can affect the flying characteristics of projectiles in a very positive way and thus the hitting accuracy. The projectiles are put into a flight-stabilizing self-rotation during launching due to gun barrels. The friction-reducing structuring can be employed longitudinal to the direction of motion and also in any twisted form, also longitudinal to the direction of motion, comparable to the helical shape in the launching device.

Furthermore, all surfaces of the possibly required throwing, acceleration or launching devices for the application of the accelerated bodies can be equipped with the surface, according to invention, since here both, the friction-reducing and also the self-cleaning and all other advantages of this surfaces facilitate their use and they can also increase the performance.

Due to the surfaces, according to invention, applied to these objects, deviations caused by wind, side wind, thermal movements of the air, squalls, rain, etc. are less problematic since the object react to those in a less sensitive way.

### EXAMPLE 16

Structures to reduce draft, but also possibilities to improve breathing activity and exchange of gas and air.

A simple application example of these application possibilities can be demonstrated based on glasses.

In this case, a formation can be developed in such a way that glasses, e.g. for use during sports activities, e.g. for bicycling, can be developed as follows:

Any parts of the glasses, but also the whole frame which can be designed in a relatively wide way to protect against draft, dust and air-stream during motion, etc. can be developed in such a way that the surface can be made of any materials and possessing friction-reducing surfaces, e.g. as rib/groove structure, which can be mainly aligned in the direction of travel.

This enables reduced air friction with the surrounding media (in particular air-stream during motion/rain, etc.). Besides that, any surfaces of the glasses can be moreover equipped with self-cleaning surfaces. In any case this results in a reduced tendency of soiling. In addition to that self-cleaning surfaces can also take over other, important tasks.

If these self-cleaning surfaces are developed e.g. in the form of burl-type protrusions, they can either be separate or they can be directly combined, e.g. with the friction-reducing structures.

A possible type of formation can be developed in a way that the burl-type surface structures can be equipped with openings which enable air exchange between the relatively still, warm, moist air under the glasses and the air outside the glasses, above all, this can be achieved without problems occurring with respect to dirt, direct air-stream during motion, other irritating substances or materials, etc., since the friction-reducing surface produces kind of a still air cushion between the protrusions and thus problems will not occur regarding air-stream during motion, etc., but gas and moisture exchange (prevention of steaming up of the inner surface of the glasses) can very well be ensured.

### EXAMPLE 17

In the sector that relates to textiles, clothing and other equipment elements, e.g. working clothes and leisure wear can be regarded as interesting application range.

Especially in applications, where severe soiling, dangerous soiling and contamination occur, but also for unwanted soiling, a self-cleaning surface is, of course, very suitable. In addition to this a friction-reducing surface can complement the self-cleaning surface, improve it and expand the application range enormously.

It is important for many applications, for example, for work and leisure, to be affected as little as possible by flow-around media.

In many sectors this is even very important and also enhances safety.

Many people are exposed to strong flows of moving, in particular fluid media, such as flows of water, flows of air, but also suddenly rising squalls and other changing flows, often this occurs in combination with own movements or other movements. Some examples are: clothing for motorcyclists, swimming and diving suits, clothing of platform workers and sewermen, as well as protection clothing, in general, against rain and wind, as well as e.g. leisure wear, like for hang glider pilots, winter sports wear, neoprene suits for surfers, clothing to go fishing, in particular river fishing, etc., as well as all suitable equipment articles, such as gloves, helmets, boots, etc.

The application of the surfaces, according to invention, can, of course, be employed for all pieces of clothing, textiles and equipment articles. For example also, to prevent friction on the inside of the clothing, above all friction with the surface of the body, to prevent skin irritation.

It is also possible to improve the air and moisture transport between clothing and skin with these surface developments, but they are suitable as well for aesthetic and design purposes.

### EXAMPLE 18

A further application range is represented by filters, e.g. filter papers.

Simple coffee filter papers can be used here as a special embodiment example, in combination with the filter holding device, required for their use.

Here, the surface, according to invention, is very well suited for several reasons, since the usual filtering process can be optimized in several respects by appropriate use of the surface, according to invention, in the respective embodiment. Normally, filter papers consist of water-permeable fibrous material, furnished with pores. During scalding, the ground coffee particles are being floated and the water-soluble, flavor-containing particles are to be washed out (final product coffee). Some of the disadvantages of these filter papers are, among others, that part of the scalded ground coffee will deposit on the walls of the filter and stay there. This entails that both, floated material, to some extent completely unwashed (dry ground coffee), stays on the upper edge zones, as well as ground coffee which was partially washed out. The reasons for this behavior are based on physical facts (density, etc.) and they can also be attributed to the topology of the filter.

Now, these problems can be eliminated by using the surface, according to invention, and also there are other positive characteristics. A possible version of a coffee filter paper in this respect can be developed as follows:

The inside of the filter paper, in particular, can be equipped with a combination of the formations of the surface, according to invention, to reduce and/or prevent adhering of ground coffee, and also to ensure transport of the coffee in filtering direction as frictionless and as continuously as possible.

This way the ground coffee can be completely washed out since it will always slide down to the bottom of the filter and it is also prevented that the ground coffee can form a pore-closing clinging mass at the base of the filter, thus ensuring unhampered draining of the finished coffee in an unlimited way.

Moreover, the finished coffee is directed towards the draining possibility in a well-aimed way, supported by the surface, according to invention, and also draining of the end product can be affected in a well-aimed way in combination with a surface of the filter paper holding device, also developed according to invention.

By structuring the outside area of the filter and also the inside of the filter holding device, according to invention, it can be additionally achieved that due to the entrapped air, there is no clinging of the filter to the filter holding element.

### EXAMPLE 19

It is especially advantageous to apply the surface, according to invention, to surfaces of objects showing perceptible reactions if subject to the influence of moving media.

The advantages which can be achieved can be demonstrated clearly based on musical instruments, and here wind instruments. With wind instruments, an air flow produced by a person is induced through a tube-type body, mostly in combination with resonance-producing body formations finally causing perceptible resonance (music).

The air current, among other things, mixed with particles (saliva), moisture and germs, produces vibrations in certain areas of the object and is discharged via an opening.

By using an advantageous implementation of the surface, according to invention, like e.g. an implementation causing an accelerating or reducing effect on the air flow, the mode of operation of the instrument thus can be affected. Function, hygiene and maintenance can be facilitated by combination with self-cleaning surfaces, in particular in the area of the mouthpiece as well as in such areas used for collection and discharge of the above mentioned particles and materials admixed to the breath air.

The surface, according to invention, can also be applied to all other surfaces of such an object. Here too, advantages can be achieved with respect to maintenance, function as well as optical developments.

### EXAMPLE 20

A further application range of the surface, according to invention, can be represented by such objects where the surfaces, among other tasks, are used for affecting the direction of, control and transport of existing and developing media, in particular fluid media.

A suitable application example is represented by the surfaces of solariums which are well suited for self-cleaning surfaces based on the way they are used. Many advantages can be achieved by employing these self-cleaning characteristics compared to the devices which are presently being used, however, evident advantages are achieved only by means of the combination, according to invention, with additional surface characteristics.

This can be implemented as follows:

In a special formation of the application of the surface, according to invention, the bearing area, in particular, can be developed accordingly, besides other surfaces of the object.

The mainly transparent bearing area can be developed as application formation of the surface, according to invention, in the following way.

A large number of advantages can be achieved by an advantageous combination of the surface characteristics, according to invention. It is possible to purposely drain developing fluid media (sweat) away from the body by appropriate structures in the form on protrusions and recesses and also to subsequently discharge into certain areas available for that purpose.

By combination with self-cleaning surfaces it is furthermore possible to quickly and easily clean all the surfaces, deposited by particles, germs and other media. Likewise all other areas and surfaces, but in particular those, which can be deposited by germs or other undesired materials.

It is, for example, possible to accelerate or affect the discharge of the undesired materials by purposely supporting or affecting the flow characteristics.

It is also possible, to combine applications, mechanisms, etc., supporting the self-cleaning in any way with the application of the surface, according to invention.

In addition to that, the surface structures, according to invention, can also be employed to direct electromagnetic waves (e.g. electromagnetic radiation in the form of light) in a well-aimed way, e.g. by using transparent surfaces with transparent protrusions, to achieve desired effects (e.g. uniform tan by uniform scattering of the respective ultraviolet light).

This embodiment variant can of course also be applied to any applications.

### EXAMPLE 21

All surfaces of devices used for production of flows or for conversion of flows into other forms of motion or energy, such as propellers, rotors, fans, aerofoils and marine wings, air and marine screws, air and marine propellers and air and marine blades, are also suited to be improved by the surface formations, according to invention. By using the surfaces, according to invention, friction of the moving device with the surrounding media can be reduced resulting in lower energy consumption or higher energy gain, furthermore it is possible to protect the device's surface at the same time against deposit and soiling.

### EXAMPLE 22

All kinds of sports and leisure devices as well as working devices in the form of striking devices and striking elements, which are to be moved through one medium or several media or which are to be accelerated, such as striking elements and striking devices, in particular bats and clubs to move and/or accelerate bodies such as balls, shots, pucks, etc.

A golf club can be regarded as a special example, which can be improved by means of the surfaces, according to invention, to the effect that any surfaces, such as handle, shaft, head, etc., possess better characteristics due to reduced friction with the surrounding media. This can mean, e.g., faster striking movements due to reduced air friction, and also increased striking force, less energy effort for the drive itself, and also less sensitivity against wind and thus more precise drives.

Less soiling and easier cleaning are ensured due to the surfaces, according to invention.

Due to the application of suitable structures which are mainly applied across the force effect, it is furthermore possible to ensure a safe grip and also to achieve a moisture-discharging effect during moist or wet conditions (rain, atmospheric humidity, water impairments, sweat, etc.).

Moreover, the club head can be improved by means of the surface developments, according to invention, at the area where the ball is to be hit.

### EXAMPLE 23

All kinds of moving transport elements and containers and/or elements and containers flown-around by moving materials, such as e.g. ski carriers, ski boxes, bicycle carriers, load carriers, etc.

Especially transport containers, like e.g. ski boxes, can be considerably improved by the surfaces, according to invention. In this device, both the box itself and also the respective carriers can be improved in a multitude of ways. By application of the directed, friction-reducing surface, structured in accordance with the surrounding medium (air), it is, for example, possible to achieve reduced fuel consumption as a result of improved air drag coefficient, if the whole surface (top and bottom side) of the box is structured in that way.

By applying a comparable structure, e.g. only to the bottom side, a higher descending force can be produced due to the acceleration of the air under the box, to achieve a better motion stability. In a further example, however, the upper side can structured in direction of motion, the lower side, as a whole or to some extent, can be structured across the direction of motion, to achieve better side wind characteristics.

This way two surface structures, structured the same way but applied in different directions, can be applied to two different surfaces of a device, developed for the same medium, to fulfil different tasks.

Furthermore, better self-cleaning and/or less tendency of soiling can be ensured by a non-directed structure on the device. This structure, however, works in this application in the same medium (air), like the directed structures, but fulfilment of its main task will only be ensured by a second medium (liquid). On top of that, this surface, according to invention, features less sound caused by air-stream during motion as well as better motion characteristics of the vehicle with the device. This applies in particular, if suitable materials are used for the production of the structures.

### EXAMPLE 24

All kinds of moved or accelerated elements, such as balls, e.g. golf, badminton, volleyball, handball, etc.

### EXAMPLE 25

All kinds of rudders, paddles, sticks, etc., like e.g. ski poles, possessing improved characteristics due to the surfaces, according to invention.

Some developments of the surface, according to invention, are described hereinafter.

The invention describes surfaces, possessing structuring, which can be applied permanently or in a removable way. All surfaces, as well as all structures, can consist of suitable materials as well as material combinations, to be adapted to the respective applications and the surrounding media and be most suitable for these.

The form of the protrusions and recesses of the directed structures can show any formations, but in particular it is to be applied in V-shape, U-shape, L-shape and triangular shape. Furthermore, the surface developments, according to invention, can be applied together with other, already existing structures or structures applied later on.

All directed structures can consist of sharp-edged, as well as not sharp-edged, as well as movable elements or elements movable to some extent.

The individual elements of the structures, according to invention, can be of any size within the specified size range. They can vary with respect to height and width of the protrusions and/or recesses.

Furthermore, the lengthwise directed protrusions can be developed in scale shape. These protrusions can be rigid, movable, as well as also shiftable and elastic.

Besides that the directed structures can be developed in wave shape and/or they can be constructed to the effect that (elastic) they can move in a wave-shape or S-shape way. Moreover, the protrusions can also be aligned in a non-parallel way, in a way approaching each other, merging into each other, diverging from each other, as well as diminishing and disappearing, they also can be constructed wave-shaped in an ascending or descending way.

Non-direction controlled structures, mainly in the form of burl-shaped protrusions can also be made of all suitable materials, and they can be produced or applied with all suitable production methods.

Furthermore they can be developed in most different embodiments and they can also be combined with any structures.

Both structures can be both, applied to one and the same surface arranged besides each other in a non-mixed combination arrangement, and also they can be applied on the same surface in the form of a combination of both structures, where e.g. the protrusions of the lengthwise directed larger structures can be covered by smaller elements of the non-direction controlled structure form as a whole or to some extent. Also a comparable combination of non-direction controlled structures between the directed protrusions or at the sides of the protrusions.

The surfaces, according to invention, can also be applied in the form of films, fabrics, coatings and coats of lacquer to the respective substrate.

All surfaces can be structured with the structural shape, size, best suitable for the respective medium in any combinations.

All surfaces described, equipped with combinations of individual or several structures, can be completed with, replaced by or combined with other materials, structures or elements which possess comparable characteristics.

In doing so, boundary layer-affecting, e.g. friction-reducing as well as self-cleaning characteristics, effects, structures, etc., can be achieve or enabled with any other surface structures, materials, applications, procedures, methods, etc., producing comparable characteristics.

Examples are phobizing substances and materials, but also e.g. extremely hydrophilic coatings (no-drop coatings), suitable for the respective fluid media, as well as surface coatings with any boundary layer-affecting or self-cleaning materials, structures, etc., and/or materials, structures, etc. supporting the self-cleaning.

Furthermore, a boundary layer-affecting, friction-reducing effect can also be achieved, e.g. by gas or liquids beading out, as well as by applying adhesive materials or materials which are adhesive to some extent (oils, mucous substances, etc.), which can have a boundary layer-affecting effect due to their characteristics.

### DESCRIPTION OF FIGURES

Further details of the invention are described in drawings, based on schematic embodiment examples which are not according to scale.

FIG. 1 shows a cross section, not according to scale, through a possible embodiment of an element of the surface, according to invention, in the form of a mainly directed, friction-reducing surface.

The rib-shaped protrusions are marked by h, the distance of the trapezoid recesses between the ribs by s and the angle, the ribs form with the base area is marked by α.

FIG. 2a-2f show top views, not according to scale, on possible embodiments of a further element of the surface, according to invention, in form of mainly non-directed, burl-shaped, self-cleaning surface developments.

FIG. 2a-2d show relatively uniform surfaces with different dimensions of the protrusions, equipped with uniform but non-directed distributions.

FIG. 2e shows a top view on a development of a surface variation, according to invention, consisting of at least two different non-directed types of protrusions. This is only one embodiment example which possibly consists of two different materials, the same materials which are to fulfil identical (self-cleaning) tasks or which can take over different tasks.

FIG. 2f also shows a top view on a development of a surface variation, according to invention, consisting of at least two different non-directed types of protrusions. However, this is only one embodiment example which possibly consists of two different materials, the same materials which are to fulfil identical (self-cleaning) tasks or which can take over different tasks. In this case, however, the smaller protrusions are not everywhere, moreover, they are only applied in-between the larger protrusions.

FIG. 2g-2m also show variants of non-directed, mainly self-cleaning surfaces, however, in cross-sectional drawings which only represent some different developments of this surface variant, consisting of protrusions and recesses.

FIG. 2g shows a surface variant, not according to scale, consisting of burl-type protrusions of the same size, with the same distances in-between the protrusions.

FIG. 2h shows a surface variant, also not according to scale, consisting of two burl-type protrusions of differing heights, with similar distances in-between, however, with differently arranged protrusions.

FIG. 2i-2l show further surface variants, also not according to scale, consisting of burl-type protrusions, of at least two different heights, with similar or different distances in-between, as well as differently shaped and differently arranged protrusions.

FIG. 2m shows a surface variant, also not according to scale, comparable with top view FIG. 2g, consisting of at least two different burl-type protrusions, with similar or different distances in-between, as well as differently shaped and differently arranged protrusions, where it is possible here, too, that smaller protrusions can sit on larger protrusions, at least to some extent.

FIG. 3a-3n all show cross-sectional drawings of possible implementations of mainly directed, boundary layer-affecting surface structures, in different implementations, all materials and shapes can be employed in all combinations. They show different implementations, not according to scale, of mainly lengthwise directed rib/groove micro-structures.

FIG. 3a shows trapezoid structures, consisting of triangular protrusions, where recesses of trapezoid shape result from certain distances between the protrusions.

FIG. 3b shows comparable triangular protrusion structures, however, they are arranged together in such a way that the recesses in-between only show triangular structures.

FIG. 3c also shows triangular protrusions, however, of different sizes and arrangement, as well as located at different areas of the surface. This way the smaller structures can be both, micro-structures on the upper side of recesses of other, coarser rib micro-structures, and also rib structures on the upper side of recesses, forming coarser structures on the surface of an element.

FIG. 3d shows comparable lengthwise directed micro-structures, as shown in FIGS. 3a and 3b, however, in the form of finer, steeper triangular structures.

FIG. 3e-3h also show lengthwise directed triangular micro-structures, in different developments, to the effect that structures of the same kind (triangle) are shown here, however, they possess different inclination angles of the individual smallest ribs, and also different distances in-between the ribs, as well as combinations of structures with identical inclination angles and the same basic rib shapes, but different heights and distances in-between the individual structures.

FIGS. 3i and 3j show comparable lengthwise directed micro-structures, however, consisting of rectangular structures in terms of smallest protrusions.

FIG. 3k-3m also show lengthwise directed micro-structures. Their smallest protrusions are here shown in the form of round-walled elements.

FIG. 3n shows a different form of lengthwise directed micro-structures. Their smallest protrusions here possess the shape of very slim ribs.

FIG. 4a-4e show perspective top view on a surface, e.g. structured with triangular ribs.

FIG. 4a principally shows the comparable surface like FIG. 3a.

FIG. 4b shows a similar surface like 4a, however, with the difference that here the rib structures are not applied continuously but with spaces in-between, however, still aligned in one line (alignment) one behind the other.

FIG. 4c shows a similar surface like 4b, here different zones can be developed on the surface in the form of protrusions of different lengths.

FIG. 4d shows a similar surface like 4c, however, here a further zone is shown possessing finer structuring, also lengthwise and also aligned with the other protrusions, but, e.g. with double the number of protrusions (same heights but different inclination angles or different heights but the same/or different inclination angles) per unit of area.

FIG. 4e shows a similar surface like 4d, however, here a row of protrusions, for example, is arranged on the surface in such a way that they are no longer aligned with the rest of the protrusions. In this example the possibility is shown, that both, different rib heights and also different rib heights and groove valleys, not arranged in a row one behind the other, can follow behind each other to create a certain amount of turbulences, if required.

FIG. 5a shows a section of a perspective top view on a lengthwise directed rib structure which is equipped both in the area of the protrusions and also in the groove valleys with a variant of the self-cleaning, soil-resisting burl structure.

FIG. 5b shows a sectional drawing through a lengthwise directed rib structure which is equipped both in the area of the protrusions and also in the groove valleys with a variant of the self-cleaning, soil-resisting burl structure. However, in this example, the burls consist of protrusions of different sizes and different shape, in contrary to FIG. 5a.

FIG. 6a shows a top view on a surface equipped with two different combinations of lengthwise directed structures, according to invention. In this figure two rib structures are shown possessing different distances in-between the ribs, and they also possess a smooth surface in the edge area.

FIG. 6b also shows a top view on a surface. This surface is equipped with three different structure combinations, according to invention. It represents a surface being moved in the direction of the arrows.

The right-hand side represents a lengthwise directed structure (1), oriented in the direction of motion, consisting of ribs and grooves. Next to it there is a structure (2) which is also directed, consisting of ribs and grooves, however, aligned diagonally to the above mentioned structure. The third structure (3), according to invention, is developed in the form of lengthwise directed rib and groove structures, equipped with small, self-cleaning non-directed protrusions. Comparable with the examples in FIGS. 5a and 5b.

FIG. 7 represents in a top view, a further development of the surface, according to invention, in the form of rib and groove structures which, in contrary to the above applications, are not aligned in a parallel way but they are constructed in a way as to approach each other and/or diverge from each other. Complementary to this figure, any other structural shapes of the directed surface structure can be developed, like, e.g. completely converging ribs as well as decreasing or increasing heights of the ribs, etc.

The following figures are neither according to scale nor are they meant to represent specific sliding elements, since under this application they only serve to demonstrate the application range, variation possibilities and advantages of the improvements, according to invention. The micro-structuring shown stands in place of all possible surfaces, structured according to invention. Figures of sliding elements, in particular snow sliding elements, are shown as practical applications, as well as all objects, devices, etc., which can be used in this connection.

FIG. 8a shows an example in a cross-section of the presently used structuring of sliding soles of sliding elements.

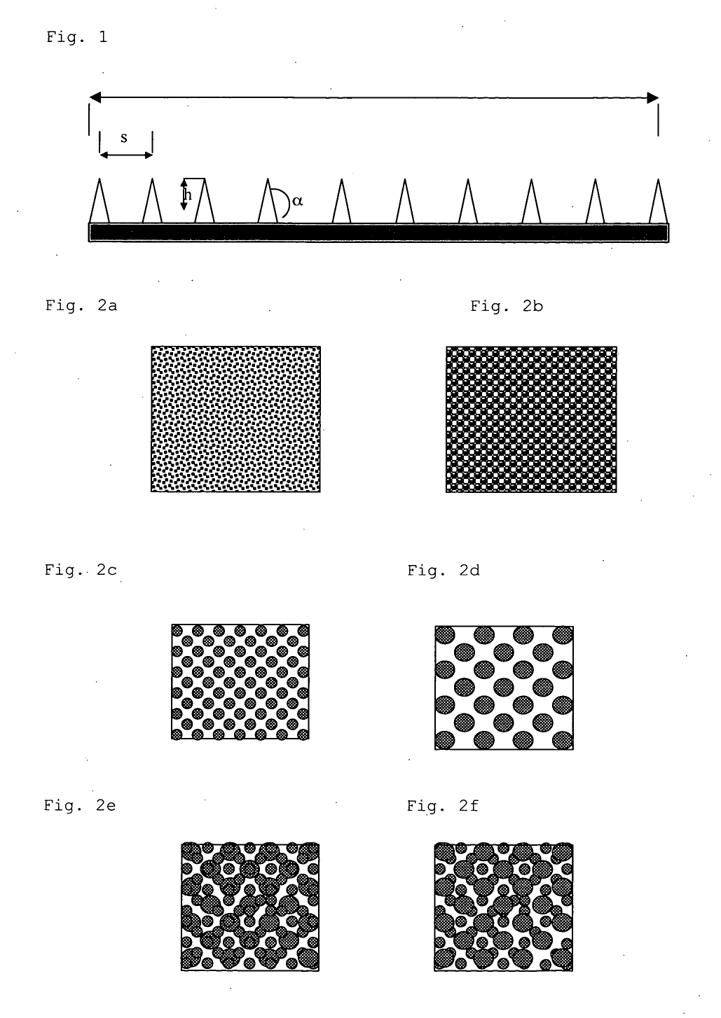

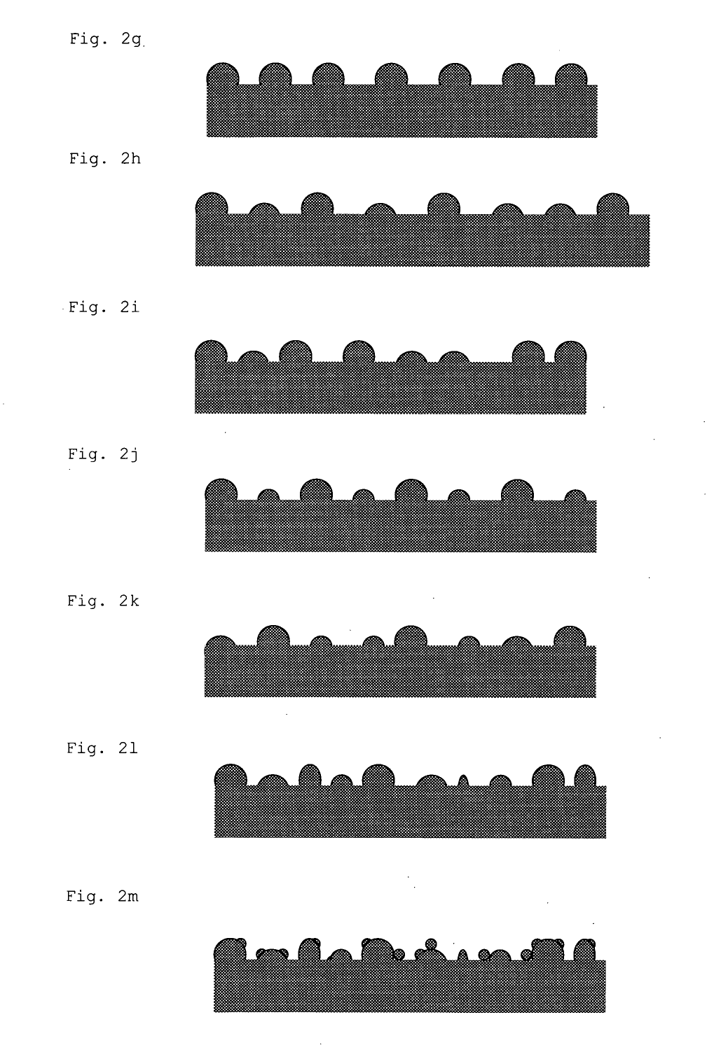

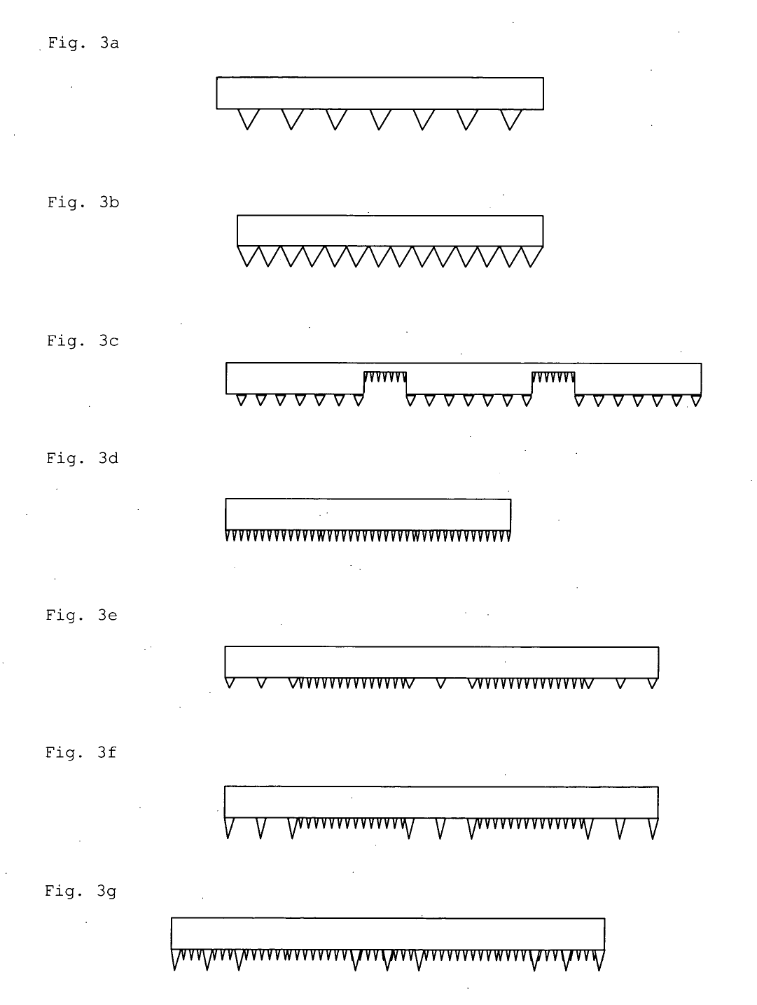

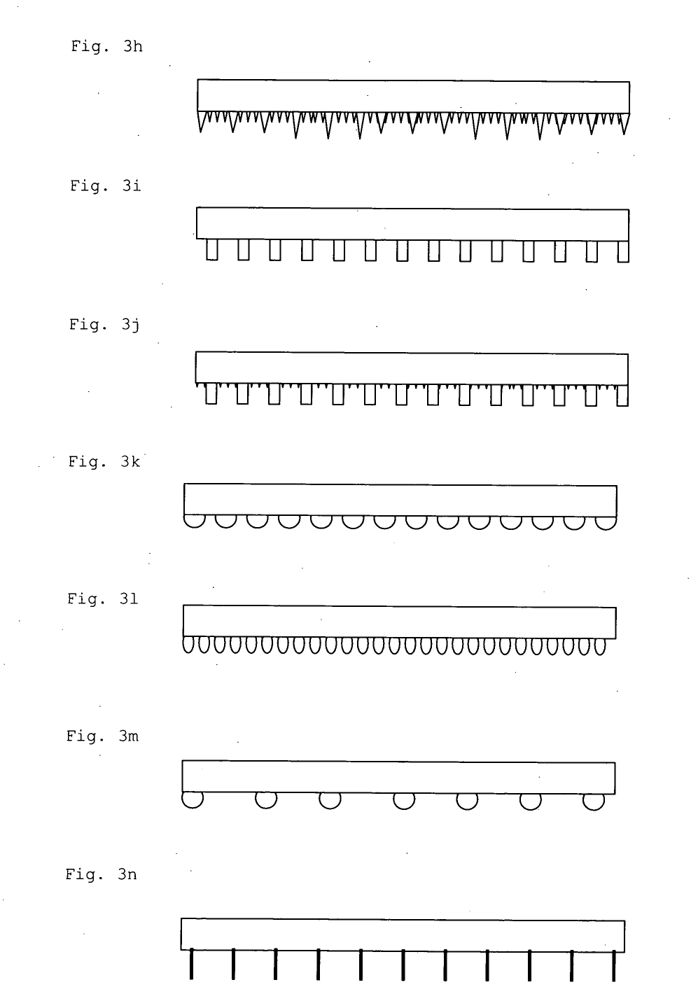

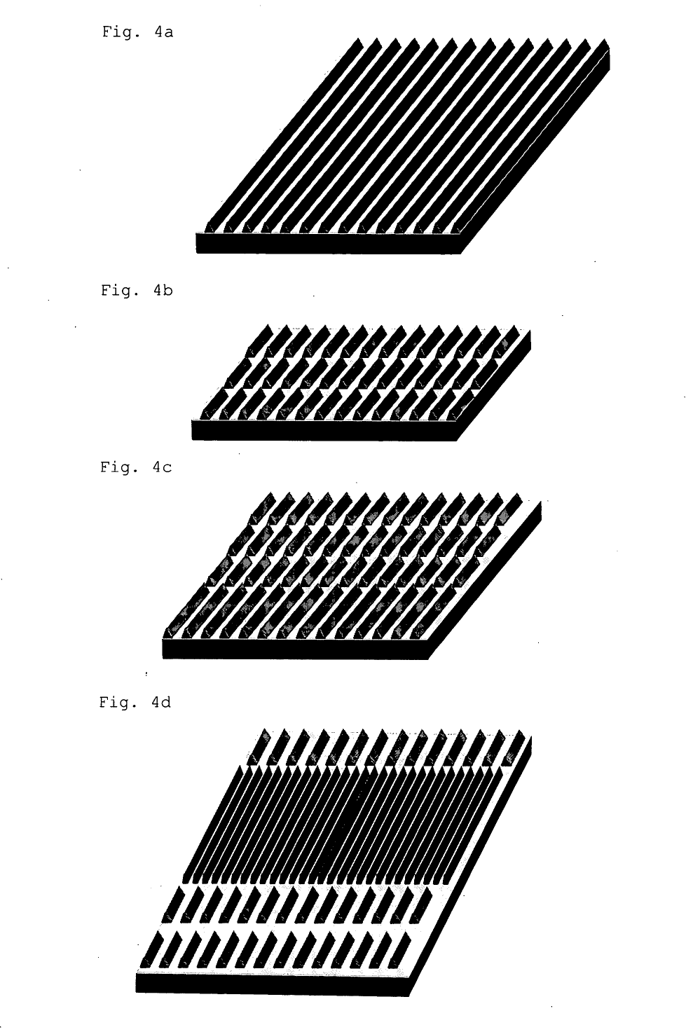

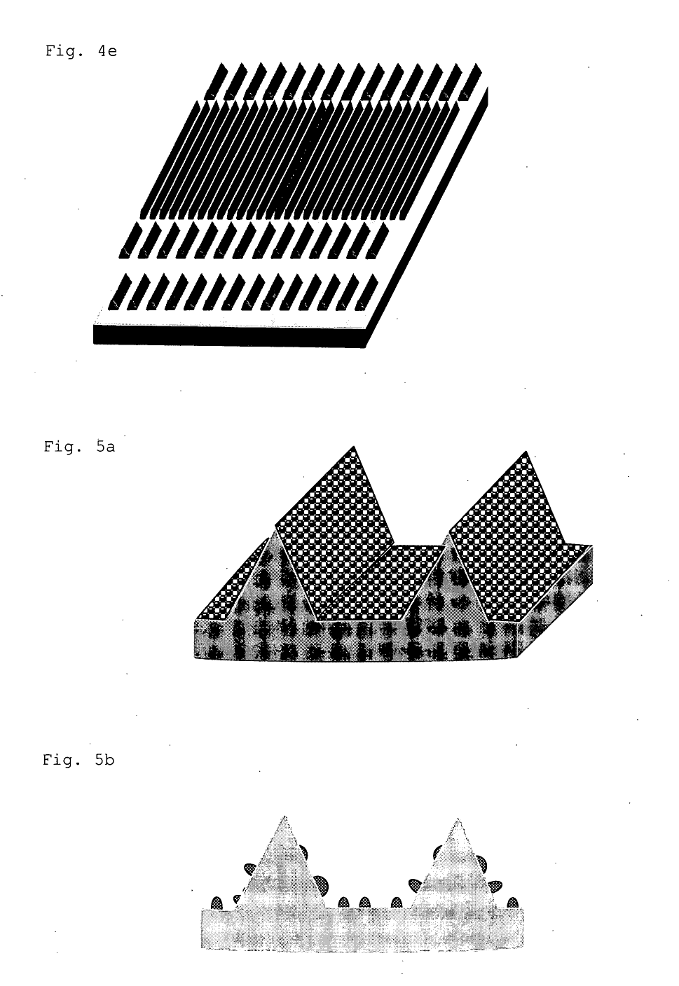

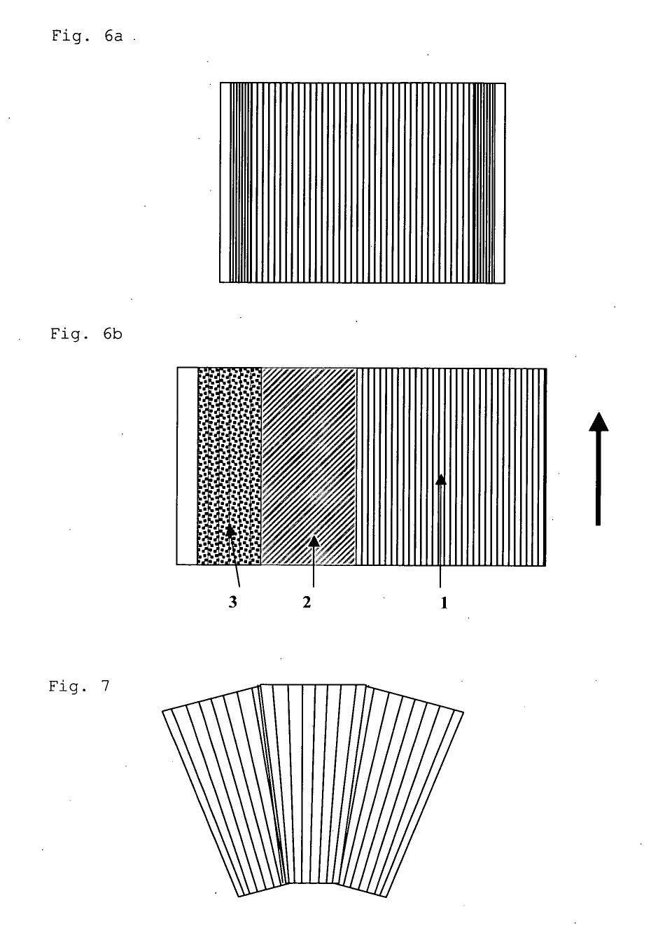

Here, there are approx. three groove-type recesses in the direction of motion within a width of 1 mm.

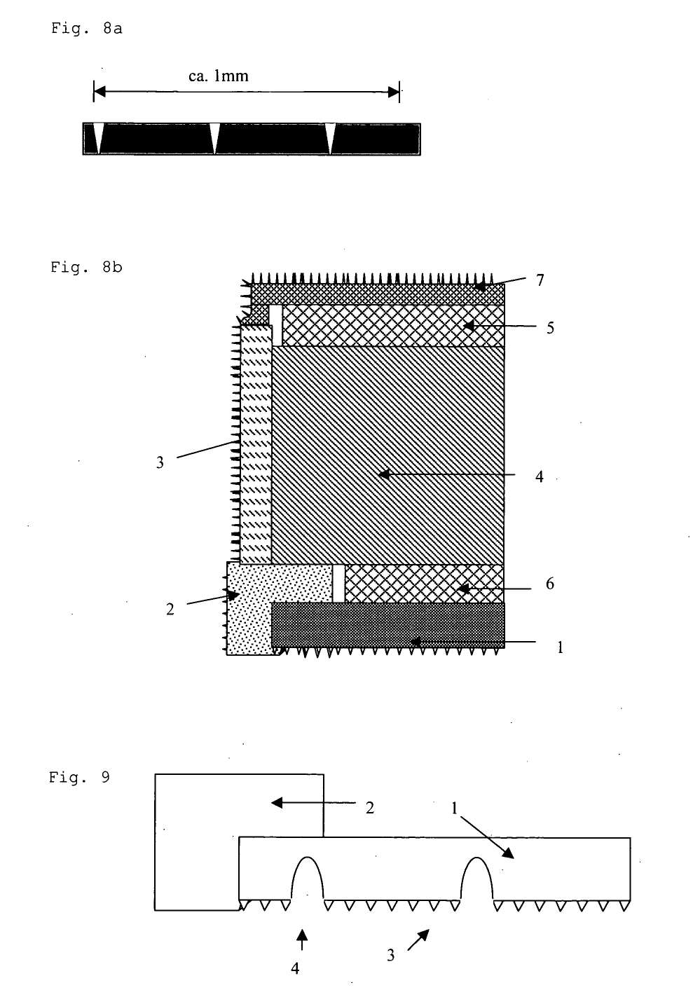

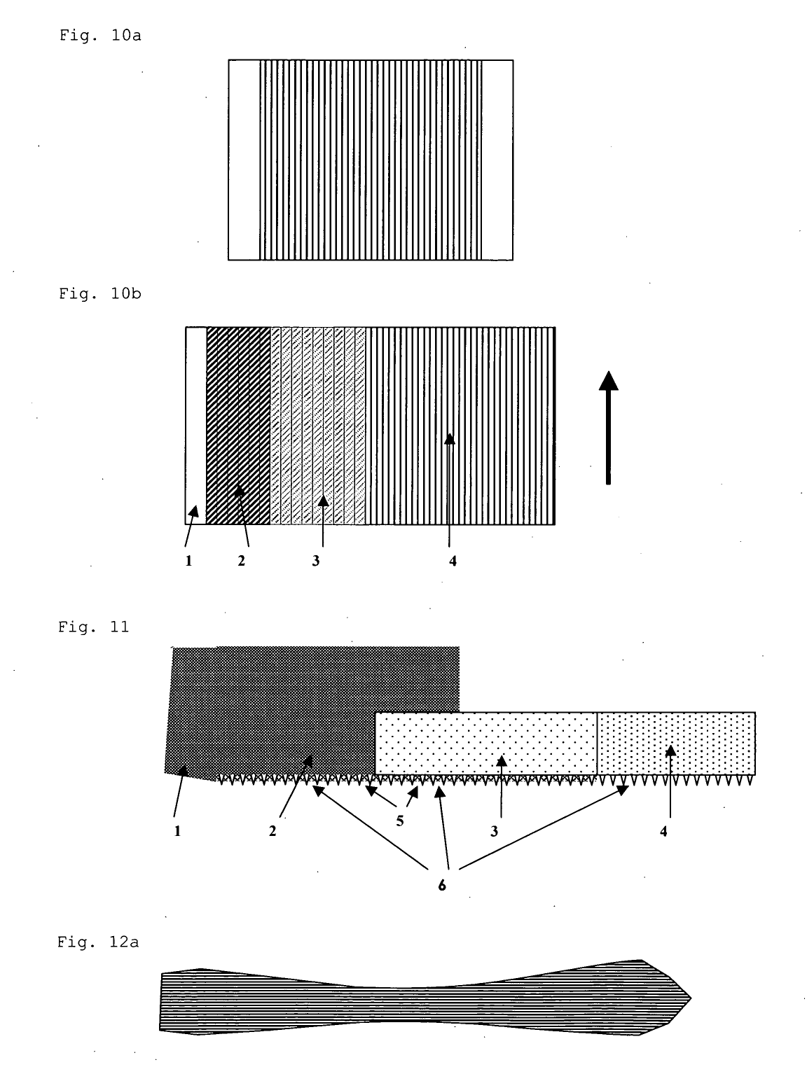

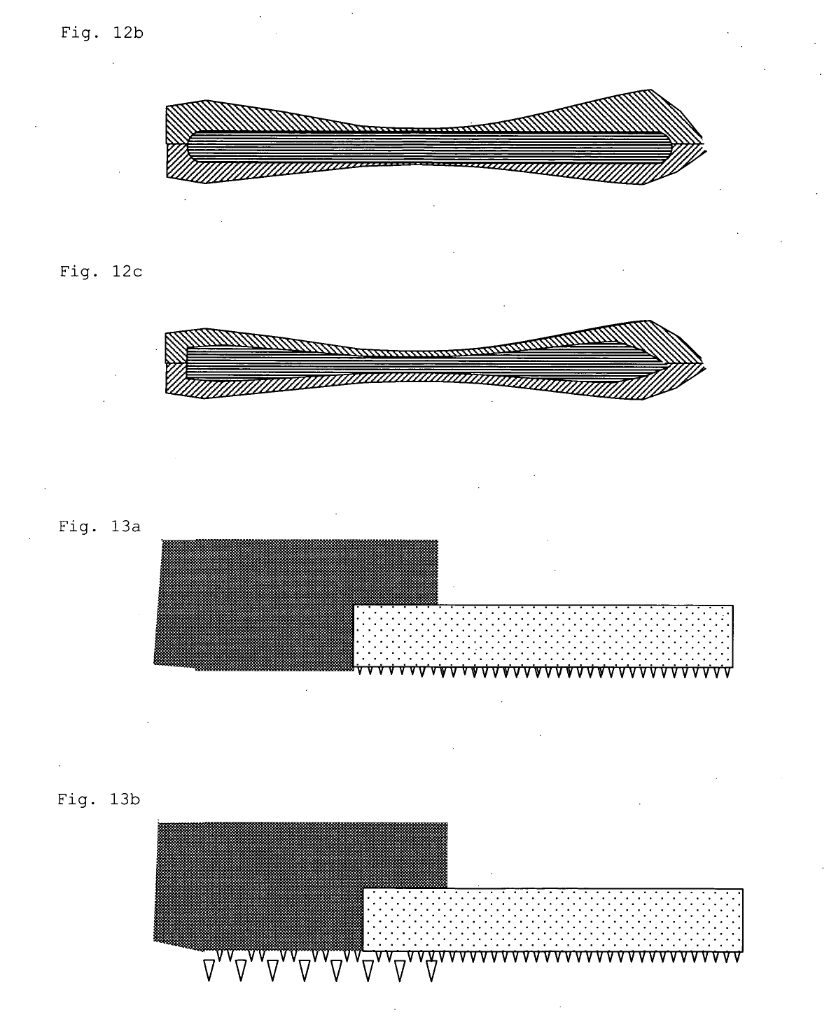

FIG. 8b represents a cross section with structuring, according to invention, on the surfaces of a ski
1.—sole equipped with micro-structuring
2.—steel edge equipped with micro-structuring
3.—sidewall equipped with micro-structuring
4.—core
5.—top strap
6.—bottom strap
7.—shell, surface equipped with micro-structuring

It must be taken in consideration, here, that all surfaces can be developed with structures, each adapted to the respective requirements. Directed as well as non-directed as well as combined structures can be applied.

FIG. 9 also represents a cross-section, where (1) shows the sole, (2) the steel edge, (4) the relatively coarse, presently used lengthwise directed structures, and (3) a formation of the also lengthwise directed micro-structuring, equipped with triangular protrusions and trapezoid recesses.

FIG. 10a shows the top view on the surface of a sliding element, based on the example of a ski sole with the two steel edges. This relates to a regular, lengthwise directed micro-structuring with ski edges on the outsides (non-structured).

FIG. 10b also shows lengthwise micro-structuring in the central ski sole area (4), micro-structuring is also applied to the outer areas of the ski sole (3) and to the inner sections of the ski edges (2), however, next to the one aligned in the direction of motion, also a version directed slanting towards the back, to enable excess water to be drained below the ground outside of the ski edge (1).

FIG. 11 shows a sectional drawing through the ski lining section shown in 10b. In this example both the ski edge are shown as well as a portion of the ski sole.

(1) shows the outmost part of the steel edge, partially ground, which does not show any structuring here. (2) represents the part of the steel edge located further inside which shows here a combination of two structures, a structure running in the direction of motion (6) and a second structure (5) running diagonally, in direction of motion towards the outside and the back in a slanting way. The area of ski's sliding surface located outside (3) shows comparable structuring. Whereas the central area, in the center of the ski's sole, only possesses a structure running in the direction of motion (6).

Due to this kind of structuring, the excess water share of the water film under the ski can be easily drained off to the outside below the steel edge.

FIG. 12a-12c show a top view on a ski sole.

12a shows a lengthwise directed micro-structure in the form of a groove/rib profile, possessing the same structuring all over the complete sole.

12b represents two possible sections of the same kind of structuring, however, with differing arrangement. In the central area, in the center of the ski's sole one can see a lengthwise directed micro-structuring, in the edge are, as well as at the tip and at the end of the ski's sole, normally areas where the ski is bent upward, the sole possesses a groove structure, aligned slanting/diagonally to the direction of motion, which runs on both sides in a way slanting to the back towards the edge area.

12c is the same like FIG. 12b with respect to the principal design, with the difference that here the lengthwise directed central area of the micro-structuring shows a somewhat different outer shape.

FIG. 13a again shows a cross section through a sliding element. Here a ski edge and the sole with its lengthwise directed microstructuring are shown.

In this figure the protrusions (ribs) of the micro-structured surface of the ski's sole form one level with the ski's steel edges.

FIG. 13b shows a further possibility where the protrusions of the structured area are not flush with the edges, but they can be e.g. applied protruding by the elevation height beyond the remaining surfaces, they can also protrude by parts of these heights.

As an additional difference, here part of the steel edges are equipped with lengthwise directed micro-structures (compare to FIG. 10a with non-structured edges, FIG. 11 possessing structures, but nearly flush).

One could assume, e.g. with respect to the raised variant (FIG. 13b) that the protrusions of the structures protrude minimally from the ski surface (however, only approx. 0.025 mm), i.e. approx. 1/40 mm with an approximate distance in-between the individual protrusions of approx. 0.05 mm.

The number of protrusions per sole, with a sole of approx. 10 cm width, would thus result in approx. 2000 ribs per ski, with a relatively fine structure of 20 protrusions per mm. Due to this high number a very stable surface can be achieved. Furthermore, stability and torsion-proof of the ski sole are increased due to the folded design of the surface (compare trapezoid sheet, corrugated cardboard).

1. Body, with a plurality of surfaces, which get in contact with different media,
wherein a first surface is provided with a first surface structuring in the micrometer range and/or in the nanometer range, wherein the first surface structuring is adapted to a first medium which gets in contact with the first surface,
wherein a second surface is provided with a second surface structuring in the micrometer range and/or in the nanometer range, wherein the second surface structuring is adapted to a second medium which gets in contact with the second surface.

2. Body in accordance with claim 1,
where the first surface structuring is developed as a direction-controlled surface structuring.

3. Body in accordance with claim 2,
where the direction-controlled surface structuring possesses protrusions in the shape of ribs and recesses,
wherein the protrusions are essentially aligned parallel to each other, and
wherein the recesses are essentially aligned parallel to each other.

4. Body in accordance with one of the claims 1 to 3, where the first surface structuring possesses scale-shaped protrusions.

5. Body in accordance with claim 3 or 4,
where at least a part of the surface of the protrusions and/or at least a part of the surface of the recesses is hydrophobic.

6. Body in accordance with one of the claims 1 to 5,
where the second surface structuring is developed as a non-direction controlled surface structuring, by which the second surface structuring provides a self-cleaning function for the second surface.

7. Body in accordance with claim 6,
where the non-direction controlled surface structuring possesses burl-shaped protrusions.

8. Body in accordance with one of the claims 6 or 7,
where at least a part of the second surface structuring is hydrophobic to ultraphobic.

9. Body in accordance with one of the claims 2 to 8,
where the first surface possesses a first surface section and at least one additional surface section,
wherein the first surface section possesses the first surface structuring, and
wherein the additional surface section possesses a direction-controlled additional surface structuring in the micrometer range,
wherein the directional orientation of the additional surface structuring is inclined at a given angle with respect to the directional orientation of the first surface structuring.

10. Body in accordance with one of the claims 1 to 9,
where the first surface structuring and/or the second surface structuring possess/possesses structures of different structure dimensions.

11. Body in accordance with one of the claims 1 to 10,
where the first surface structuring and/or the second surface structuring possess/possesses flexible protrusions.

12. Body in accordance with one of the claims 1 to 10,
where the second surface additionally possesses a surface structuring where the structure dimension is larger compared to the structure dimension of the second surface structuring.

13. Body in accordance with claim 12,
here the additional surface structuring of the second surface possesses a structure dimension in the micrometer range.

14. Body in accordance with claim 12 or 13,
where the additional surface structuring of the second surface is developed as a direction-controlled surface structuring.

15. Body in accordance with one of the claims 1 to 14,
where the structure dimension of the first surface structuring is between approx. 10_m and approx. 1 mm.

16. Body in accordance with one of the claims 1 to 15, where the structure dimension of the second surface structuring is between approx. 0.5_m and approx. 1 mm.

17. Body in accordance with one of the claims 1 to 16,
where the second surface structuring is adapted to the second medium, wherein the second medium is a different medium compared to the first medium.

18. Body in accordance with one of the claims 1 to 17,
where the first surface and the second surface form a combined surface, where the first surface structuring and the second surface structuring are arranged.

19. Body in accordance with one of the claims 1 to 18, developed as one of the following devices:
sliding element carrier,
sliding element box,
vehicle bicycle carrier,
vehicle load carrier,
sports device, especially ball striking device and/or ball.

20. Body in accordance with on of the claims 1 to 18, developed as sliding element.

21. Body in accordance with claim 20,
where at least one additional device is attached to the sliding element, which (one additional device) possesses on its surface at least partially the second surface structuring.

22. Body in accordance with claim 21,
where the additional device is one of the following devices:
sliding element brake,
sliding element binding,
sliding element binding elevation plate, or
sliding element shoes.
